(19) United States
(12) Patent Application Publication
(10) Pub. No.: US 2025/0298188 A1
(43) Pub. Date: Sep. 25, 2025

(54) TWO-DIMENSIONAL ACTUATOR BEAM FOR ADJUSTABLE OPTICAL COUPLING ON PHOTONIC INTEGRATED CIRCUIT STRUCTURES

(71) Applicant: Intel Corporation, Santa Clara, CA (US)

(72) Inventors: Chia-Pin Chiu, Tempe, AZ (US); Kaveh Hosseini, Livermore, CA (US)

(73) Assignee: Intel Corporation, Santa Clara, CA (US)

(21) Appl. No.: 18/609,860

(22) Filed: Mar. 19, 2024

(51) Int. Cl. G02B 6/125

(52) U.S. Cl. CPC G02B 6/125

(57) ABSTRACT

An apparatus comprises an integrated circuit (IC) package substrate, a photonic integrated circuit (PIC) die over or under the IC package substrate and comprising a first waveguide, and an optical component adjacent the PIC die and comprising an optical path. A beam cantilevered from a surface of the PIC die or the optical component has a second waveguide between the first waveguide and the optical path. The beam comprises a first plate portion extending in a horizontal or vertical plane, and a second plate portion distal from the first plate portion along a length of the beam and extending transversely to the first plate portion. The second waveguide extends along both the first and second plate portions.

### BACKGROUND

Optical electronic devices such as photonic integrated circuit packages can be used for several applications, such as communications. A number of different methods may be used to precisely align light being directed from one electronic optical component to another electronic optical component on the packages. One such approach for edge coupling between the components permanently attaches optical fiber arrays extending from one of the components to V-groove arrays in another of the components. These optical components may be photonic integrated circuits (PICs) and/or optical interposers, for example.

### BRIEF DESCRIPTION OF THE DRAWINGS

FIG. 1A is a schematic diagram of a cross-sectional side view of an example photonic integrated circuit (IC) package according to at least one of the implementations described herein;

FIG. 1B is a schematic diagram of a cross-sectional side view of a close-up of part of the example photonic integrated circuit (IC) package of FIG. 1A and according to at least one of the implementations described herein;

FIG. 2 is a schematic diagram of a perspective view of actuator beams on an interposer of the package of FIG. 1;

FIG. 3A is a schematic diagram of an alternative cross-sectional side view of an example photonic integrated circuit (IC) package according to at least one of the implementations described herein;

FIG. 3B is a schematic diagram of yet another alternative cross-sectional side view of an example photonic integrated circuit (IC) package according to at least one of the implementations described herein;

FIG. 4 is a schematic diagram of a side and upper perspective view of an actuator beam according to at least one of the implementations described herein;

FIG. 5 is a schematic diagram of a top view of the actuator beam of FIG. 4;

FIG. 6 is a schematic diagram of a transverse cross-sectional view of the actuator beam of FIG. 4;

FIG. 7 is a schematic diagram of a side and upper perspective view of an alternative actuator beam according to at least one of the implementations described herein;

FIG. 8 is a schematic diagram of a top view of the actuator beam of FIG. 7;

FIG. 9 is a schematic diagram of a transverse cross-sectional view of the actuator beam of FIG. 7;

FIG. 10 is a schematic diagram of a side and upper perspective view of yet another alternative actuator beam according to at least one of the implementations described herein;

FIG. 11 is a schematic diagram of a top view of the actuator beam of FIG. 10;

FIG. 12 is a schematic diagram of a transverse cross-sectional view of the actuator beam of FIG. 10;

FIG. 13 is a schematic diagram of a detailed side and upper perspective view of an alternative actuator beam according to at least one of the implementations described herein;

FIG. 14 is a schematic diagram showing a simplified top view of the actuator beam of FIG. 13 with a range of horizontal displacement;

FIG. 15 is a schematic diagram showing a simplified side view of the actuator beam of FIG. 13 with a range of vertical displacement;

FIG. 16 is a schematic diagram of a detailed side and upper perspective view of another alternative actuator beam according to at least one of the implementations described herein;

FIG. 17 is a graph showing expected beam displacement depending on piezoelectric actuator position along an actuator beam;

FIG. 18A is a schematic diagram showing a simplified top view of an example actuator beam with a range of horizontal displacement according to at least one of the implementations herein;

FIG. 18B is a table of horizontal displacement per volt applied for various piezoelectric actuator thicknesses for the beam of FIG. 18A and according to at least one of the implementations herein;

FIG. 19A is a schematic diagram showing a simplified side view of an example actuator beam with a range of vertical displacement according to at least one of the implementations herein;

FIG. 19B is a table of vertical displacement per volt applied for various piezoelectric thicknesses for a proximal piezoelectric actuator of the beam of FIG. 19A and according to at least one of the implementations herein;

FIG. 19C is a table of vertical displacement per volt applied for various piezoelectric actuator thicknesses for a distal piezoelectric actuator of the beam of FIG. 19A and according to at least one of the implementations herein;

FIG. 20 is a schematic diagram showing an example two-dimensional displacement range of a distal end of an actuator beam according to at least one of the implementations herein;

FIG. 21 is a schematic diagram of an example actuator beam alignment system according to at least one of the implementations herein;

FIG. 22 is a flow chart of an example method of adjusting an actuator beam of a photonic integrated circuit package according to at least one of the implementations herein;

FIGS. 23A-23I are schematic diagrams of cross-sectional views of an example photonic package with actuator beams in various stages of assembly according to at least one of the implementations herein;

FIG. 24 is a functional block diagram of an electronic computing device including a photonic IC package substrate in accordance with various implementations; and

FIG. 25 illustrates a mobile computing platform and a data server machine employing a photonic IC package substrate in accordance with various implementations.

### DETAILED DESCRIPTION

In various implementations disclosed herein, a photonic integrated circuit package has optical components such as photonic integrated circuit (PIC) dies, optical interposers, and a package substrate. In use, waveguides defined in the various components are coupled to each other for transmitting and receiving data over optical signals. In one example in order to align the waveguides, one optical component may have cantilevered actuator beams with waveguides extending from a body and towards another optical component. The actuator beams can be actuated, moving the waveguides into a position where they are aligned in two dimensions (both horizontally and vertically) with the waveguides of the other optical component.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices that have photonic packages with optical coupling between optical components on the package.

Implementations are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary implementations. Further, it is to be understood that other implementations may be utilized and structural and/or functional changes may be made without departing from the scope of claimed subject matter. It also should be noted that directions and references (e.g., up, down, top, bottom, etc.) may be used merely to facilitate the description of features in the drawings and relationship between the features. Therefore, the following detailed description is not to be taken in a limiting sense and the scope of claimed subject matter is defined solely by the appended claims and their equivalents.

In the following description, numerous details are set forth. However, it will be apparent to one skilled in the art, that implementations may be practiced without these specific details. In some instances, well-known methods and devices are shown in block diagram form, rather than in detail, to avoid obscuring the implementations.

Reference throughout this specification to “an implementation” or “one implementation” or “some implementations” means that a particular feature, structure, function, or characteristic described in connection with the implementation is included in at least one implementation. Thus, the appearances of the phrase “in an implementation” or “in one implementation” or “some implementations” in various places throughout this specification are not necessarily referring to the same implementation. Furthermore, the particular features, structures, functions, or characteristics may be combined in any suitable manner in one or more implementations. For example, a first implementation may be combined with a second implementation anywhere the particular features, structures, functions, or characteristics associated with each of the two implementations are not mutually exclusive.

As used in the description and the appended claims, the singular forms “a”, “an” and “the” are intended to include the plural forms as well, unless the context clearly indicates otherwise. It also will be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular implementations, “connected” may be used to indicate that two or more elements are in direct physical, optical, and/or electrical contact with each other. “Coupled” may be used to indicate that two or more elements are in either direct or indirect (with other intervening elements between them) physical, optical, or electrical contact with each other, and/or that the two or more elements co-operate or interact with each other (e.g., as in a cause and effect relationship).

The terms “over,” “under,” “between,” and “on” as used herein refer to a relative position of one component or material with respect to other components or materials where such physical relationships are noteworthy. For example, in the context of materials, one material or structure disposed over or under another may be directly in contact or may have one or more intervening materials. Moreover, one material disposed between two materials may be directly in contact with the two materials or may have one or more intervening materials. In contrast, a first material or structure “on” a second material or structure is in direct contact with that second material/structure. Similar distinctions are to be made in the context of component assemblies where a first component may be “on” or “over” a second component.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

A two-dimensional actuator beam for adjustable optical coupling on photonic integrated circuit structures is described herein.

Co-package photonics (with both semiconductor and photonic components on integrated circuits) have not achieved high yield and highly scalable assembly processes due to frequent misalignment of waveguides. Specifically, conventional edge optical coupling (at an edge or side of a PIC for example) is used to attach fibers from one optical device, such as an interposer, directly onto V-grooves etched into silicon on a PIC. This is a permanent connection with no ability to adjust waveguides if the waveguides are misaligned along an optical path resulting in no light signal being transmitted through the waveguides. This can occur when variation in temperature such as with temperature cycles during assembly, or changes in temperature during use, cause thermal expansion of the package substrate, thereby causing the substrate to warp, often up to 3-5 microns, during or after the assembly process. Also, optical components including PICs and interposers may warp, shift, or expand differently due to differing coefficients of thermal expansion as well. This in turn misaligns waveguides with each other that are on the multiple optical components on the package substrate. Another cause for waveguide misalignment includes manufacturing tolerances with placement of the PICs, interposers, and so forth next to each other on a package substrate. Also, the V-groove coupling also is known to be a slow process, incompatible with other conventional semiconductor packaging processes, and can result in substantial yield and throughput issues.

Since the optical components often require very precise micro-meter-level alignment between each other, the package flaws mentioned above can introduce offsets between the optical components that are so severe that the flaws can result in high insertion loss, and in turn, loss of an entire package that may have expensive semiconductor chips and silicon chiplets on the package.

One attempt to reduce the impact of the warpage is to reduce the waveguide pitch for polymer waveguides, such as down to 50 microns, so that at least warpage is reduced between the waveguides. However, the polymer waveguide may not be easily incorporated in the standard photonic process technology when using a Silicon on Insulator (SOI) process.

Another attempt at waveguide alignment is to use actuator beams that are cantilevered from one optical component, such as an interposer, to extend toward a waveguide on an adjacent structure, such as a PIC die. These beams are one-dimensional and bend in a single direction (horizontal or vertical but not both) to align a waveguide on the beam with the waveguide on the PIC die. With only a single degree of freedom it may not achieve sufficient waveguide alignment, especially for packages that require very accurate waveguide alignment, such as less than one micron misalignment

To resolve these issues, a present photonic integrated circuit package is disclosed and has at least two optical components where one of the two optical components has at least one two-dimensional cantilevered actuator beam with beam one or more waveguides to be aligned with waveguides of the other optical component. Two actuators, such as piezoelectric actuators, may be placed on the same actuator beam, one being placed at a proximal plate portion of the beam near a proximal end of the beam where the beam extends out from a body of the optical component, and the other actuator being placed at a distal plate portion where distal is relative to the proximal plate portion. The plate portions on the same beam extend in different directions transverse to the length of the beam, such as where one portion extends horizontally and the other portion extends vertically. This provides a thin bendable region that bends in a different direction at each plate portion of the beam. One of the actuators is used to generate the vertical displacement of the beam by bending the beam up or down, and the other actuator is used to generate horizontal displacement by bending a portion of the beam left or right. By one form, at least one waveguide extends along a length of the beam, through the proximal and distal plate portions, and to align to waveguides on the optical component facing the free distal ends of the beams. While the beams described herein have a single waveguide on an individual beam, it will be understood that multiple waveguides could be present on a single beam.

Each actuator can be individually controlled so the free distal end of each beam can be moved independently of the other beams and can move within a square or rectangular area to achieve good alignment between the beam waveguide and the waveguide on the facing optical component. The up and down, or vertical, displacement of the beam end may mainly compensate for the substrate warpage, while the sideways or horizontal displacement of the beam end may mainly compensate for manufacturing tolerance, assembly errors, thermal expansion, and so forth.

Thus, such a two-dimensional actuator beam arrangement can be adjusted dynamically for good alignment even when package and PIC warpage, thermal expansion or other environmental conditions, or the other flaws mentioned above exist in a package. The present approach permits adjustment of the actuator beams so that the beam waveguide sufficiently aligns with a waveguide on a facing optical component. Also, this approach will work for a variety of fiber (or waveguide) pitches when an array of actuator beams are being used to align to an array of waveguides. The actuator beams also are adaptable for use between a number of different optical components, whether between a PIC and interposer, between two PICs, between an embedded PIC (ePIC) to glass photonic package substrate with waveguides, between PIC or substrate and a fiber optic array unit (FAU), and so forth. As a result, the approaches presented herein can provide a high-yield, high-throughput optical packaging solution, allowing for the provision of high-quality and low-cost waveguide alignment between the electronic optical components or devices.

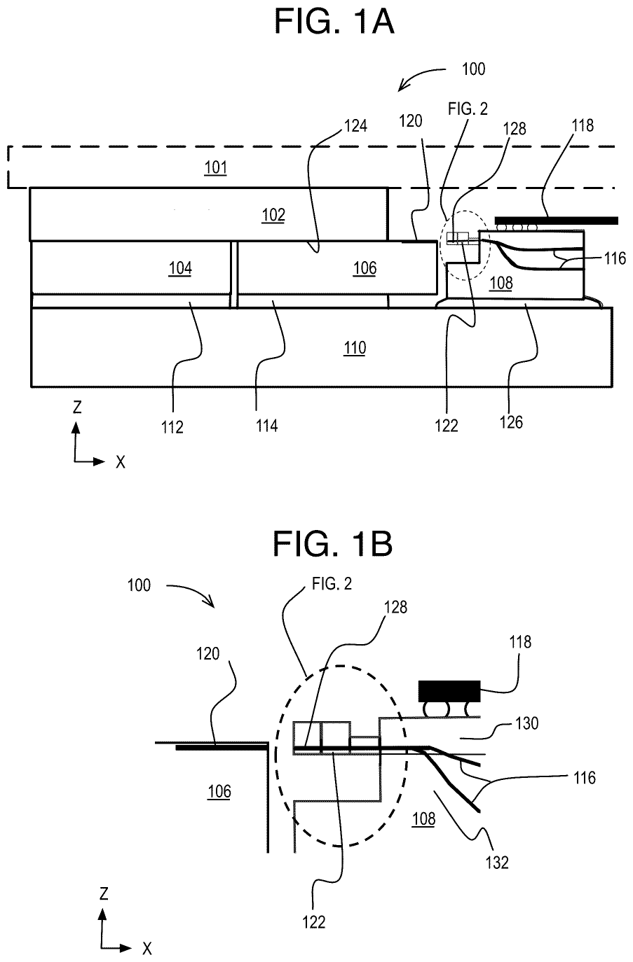

Referring to FIG. 1A, one example photonic integrated circuit (IC) package 100 may include a package substrate 102 over or under a circuit board 101, one or more electronic integrated circuit (EIC) dies 104, one or more photonic integrated circuit (PIC) dies 106, one or more optical interposers (or just interposers) 108, and in this example, an integrated heat spreader (IHS) 110 that may cover the other components. One or more waveguides 120 may be in or on the PIC die 106 and extend toward another electronic optical component on the package 100, such as the interposer 108 in this example.

The substrate 102 may be a silicon-on-insulator (SOI) substrate or may be made of ceramic, glass, and/or organic-based materials with fiberglass and resin, such as FR-4 with a silicon layer and a layer of silicon dioxide (or silicon oxide), but could have many different materials. The circuit board 101 may be made of ceramic, glass, and/or organic-based materials with fiberglass and resin, such as FR-4. The circuit board 101 may have any suitable length or width, and may support additional components in addition to the components shown here, such as additional photonic or electronic integrated circuit components, a memory device, additional circuitry, and so forth.

By another form, the package substrate 102 may include silicon or ceramic, glass, and/or organic-based materials with one or more metallization planes of copper, or other known dielectrics with fillers. By one alternative, the package substrate may be a photonic substrate and the materials of a photonic substrate are described below in detail. It also will be noted that alternatively, the EIC die 104 and PIC die 106 could be mounted directly on the circuit board 101 without a substrate. Also, any of the optical or electronic components on package 100 may have an SOI structure as well.

The EIC die 104 may include any suitable analog and/or digital circuitry, such as a processor, a memory, an application-specific integrated circuit (ASIC), a field-programmable gate array (FPGA), etc. The EIC dies 104 may be, may be part of, or otherwise include a central processing unit (CPU), a graphics processing unit (GPU), or any other specific function or type of processing unit (XPU). The EIC die 104 also may include any suitable electronic integrated circuit component, such as resistors, capacitors, inductors, transistors, etc. In some examples, the integrated circuit package 100 may be a device such as a router, a switch, a network interface controller, and/or the like. In such examples, the EIC die 104 may include network interface controller circuitry to process, parse, route, etc., network packets sent and received by the IC package 100 through the interposer 108.

By one example approach, the EIC die 104 and the PIC die 106 may be coupled to the package substrate 102 by a number of different conductive features. By one form, solder balls are used. A thermal interface material (TIM) 112 and 114 may be located between the EIC die 104 and the IHS 110, as well between the PIC die 106 and the IHS 110, and may or may not be used for adhesion. The TIM 112 and 114 may be any suitable material, such as a silver thermal compound.

The IHS 110 may have copper, aluminum, tin, or other material with a high thermal conductivity. In use, a heat sink or cold plate may be mated with the IHS 110 to remove heat.

The PIC die 106 may generate, detect, and/or manipulate light, and may include various active or passive optical elements, such as waveguides, optical amplifiers, optical modulators, filters, optical detectors (photodetectors), splitters, couplers, optical elements such as optical ports for receiving light along an optical path. The PIC die 106 also may have one or more optical sources such as lasers that emit light along optical paths or waveguides that are projected into adjacent optical components such as other PIC dies, interposers, and package substrate 102 when substrate 102 is a photonic substrate. Such lasers used for optical transmissions may emit infrared or light of many other wavelengths, which may or may not be with a constant wavelength and phase.

The PIC die 106 also may include electrical devices or elements in addition to optical elements. For example, the PIC die 106 may have electrical connections to the package substrate 102 and/or to EIC die 104, such as for power delivery, sending and receiving data, and/or the like. In some forms, the PIC die 106 may be mounted on the EIC die 104, or an EIC die 104 may be mounted on the PIC die 106.

The PIC die 106 may have multiple waveguides (or optical paths or channels) 120, and by one example may include 1 to 1024 waveguides 120. The waveguides may be arranged in one or more arrays of the parallel waveguides 120 when multiple waveguides 120 are present. The waveguide 120 may or may not be completely linear and continuous. Thus, for example, a single waveguide 120 may be formed of multiple separate waveguide portions that are end-coupled to cooperatively form the waveguide 120. The waveguide 120 may or may not be placed within a V-groove. The waveguides 120 also may be exposed on a side or outer surface of the PIC die 106 facing the interposer 108 to receive or transmit light. By some examples, the PIC die 106 may have 16 or 24 waveguides 120.

The PIC die 106 also may be or have one or more internal or included dies or chiplets. When the PIC die 106 has chiplets, it will be appreciated that the electronic and optical components on the package 100 may be used for higher computational performance in smaller packages for use in various electronic products, such as computer servers, portable computers, electronic tablets, desktop computers, and mobile communication handsets, and that often now include one or more microelectronic packages that contain various combinations of semiconductor tiles, chips, chiplets, and dies that are integrated into one functional unit. These composite, or heterogeneous, IC device structures may include tiles, chips, chiplets, or dies created using diverse technologies and materials. The tiles, chips, chiplets, or dies may be stacked vertically, placed horizontally, or both. Connections between different devices may employ a variety of technologies, including direct bonding. Chiplets, rather than monolithic dies, disaggregate the circuits. The chiplets may be electrically coupled by interconnect bridges. The term “chiplet” is used herein to refer to a die that is part of an assembly of interconnected dies forming a complete IC in terms of application and/or functionality, such as a memory chip, microprocessor, microcontroller, commodity IC (e.g., chip used for repetitive processing routines, simple logic tasks, application specific IC, etc.), and system-on-a-chip (SoC). In other words, the chiplets are individual dies (or IC dies) connected together to create the functionalities of a monolithic IC. By using separate chiplets, each individual chiplet can be designed and manufactured optimally for a particular functionality. For example, a processor core that contains logic circuits might aim for performance, and thus might require a very speed-optimized layout. This has different manufacturing requirements compared to a USB controller, which is built to meet certain USB standards, rather than for processing speed. Thus, by having different parts of the overall design separated into different chiplets, each one optimized in terms of design and manufacturing, the overall yield and cost of the combined chiplet solution may be improved.

The connectivity between these chiplets is achievable by many different ways. For example, in 2.5D packaging solutions, a silicon interposer and Through Silicon Vias (TSVs) connect dies at silicon interconnect speed in a minimal footprint. In another example, called Embedded Multi-die Interconnect Bridge (EMIB), a silicon bridge embedded under the edges of two interconnecting dies facilitates electrical coupling between them. Otherwise, in a three-dimensional (3D) architecture, the chiplets may be stacked one above the other, creating a smaller footprint overall. Typically, the electrical connectivity and mechanical coupling in such 3D architecture is achieved using TSVs and high pitch solder-based bumps (e.g., C2 interconnections). The EMIB and the 3D stacked architecture may also be combined using an omni-directional interconnect (ODI), which allows for top-packaged chips to communicate with other chips horizontally using EMIB and vertically, using Through Mold Vias (TMVs) which are typically larger than TSVs.

In some implementations that use chiplets, a composite chip may have a fill dielectric layer over a backend-of-the-line (BEOL) metallization stack. A fill dielectric layer may fully surround chiplet side or surfaces, embedding a chiplet within dielectric material. A fill dielectric may stabilize and strengthen the package 100 (or composite die structure on the package), and/or provide a platform for higher BEOL metallization layers. In some implementations, a fill dielectric layer comprises an inorganic dielectric material, such as, but not limited to, amorphous and polycrystalline silicon dioxides, in some cases having a higher k than interlayer dielectric (ILD) materials. In some other implementations, a fill dielectric layer comprises an organic material, such as, but not limited to, epoxy resins and epoxy resin composites. Vias may extend through a fill dielectric layer. Vias may also interconnect upper BEOL metallization levels or embedded devices to a level M₄ and lower metallization levels. Vias may route power and/or signals to a device layer for example. The IC dies discussed anywhere herein can be chiplets. It should also be noted that much of the IC and chiplet structure mentioned above may include PIC die 106 being mounted on a substrate 102 with a photonic substrate core and dielectric layers on the bottom and top of the substrate core and that has the PIC die 106 and/or separate chiplets.

The PIC die 106 may be formed of silicon or other materials. The PIC die 106 also may include a silicon dioxide cladding layer to embed waveguides 120. By one form, the waveguides 120 may have a material of silicon, Si₃N₄, and/or SiON.

The interposer 108 may be over or under the IHS 110, and by one form, the interposer 108 may be secured to the IHS 110 by an adhesive 126 such as epoxy or other adhesive. It will be appreciated that many other packaging arrangements may be used such as where the interposer 108 may be mounted on the substrate 102 in addition to, or instead of, the IHS 110. The interposer 108 also may have any desired dimensions.

Referring to FIG. 1B, and in this example, the interposer 108 may include one or more cantilevered actuator beams 122. In one form, individual or each actuator beam 122 may have a waveguide (or beam waveguide) 128 extending along a length (the elongated dimension of the beam L (FIG. 5)). In some forms, some of the actuator beams 122 may not include a waveguide 128. In this example, each waveguide 128 is ideally directly aligned with one of the PIC die waveguides 120.

In addition, the interposer 108 may include one or more waveguides 116 for each waveguide 128. While the waveguide 128 may be considered to include waveguide 116, whether as a single continuous waveguide or including separate waveguide portions with optical end coupling, for clarity herein, waveguide 116 will be referred to as a separate waveguide from beam waveguide 128. The light carried in the waveguides 120, 128, and 116 may have any desired wavelength, such as 1,270-1,340 nanometers, 1,500-1,600 nanometers, and so forth.

The waveguides 116 in the interposer 108 may be any suitable waveguide in any suitable cladding. For example, the waveguides 116 may be silicon, Si₃N₄, or SiON waveguides in a silicon substrate. The beam waveguides 128 also have these same materials and are flexible to bend with displacement of the beams 122. In another example, the waveguides 116 may be embodied as direct-write waveguides formed using direct laser writing, in which a laser is used to locally change the index of refraction of the interposer 108 to directly write waveguides 116 in the optical interposer 108. In one example form, the interposer 108 may include a silicon dioxide layer 130 formed over a silicon substrate layer 132 such as an SOI structure.

The interposer 108 may be arranged to interface with an optical connector (not shown), such as an array of optical fibers. The optical connector may be embodied as, e.g., a mechanical transfer (MT) connector or FAU for example. The optical connector may include, e.g., 1-1,024 optical fibers. The waveguides 116 may be routed in three dimensions to an expanded array that can interface with the optical connector.

The interposer 108 may be made of any suitable material, such as silicon dioxide or silicon or glass. In various embodiments, the optical interposer 108 may be made of any suitable material that may be crystalline, non-crystalline, amorphous, and so forth, such as fused silicon, borosilicate, sapphire, yttrium aluminum garnet, and so forth. The interposer 108 may be made of, e.g., aluminosilicate glass, borosilicate glass, alumino-borosilicate glass, silica, fused silica, etc. The interposer 108 also may include one or more additives, such as Al2O3, B2O3, MgO, CaO, SrO, BaO, SnO2, Na2O, K2O, SrO, P2O3, ZrO2, Li2O, Ti, and Zn. The interposer 108 may comprise silicon and oxygen, as well as any one or more of aluminum, boron, magnesium, calcium, barium, tin, sodium, potassium, strontium, phosphorus, zirconium, lithium, titanium, and zinc. The interposer 108 may include at least 20-40 percent silicon by weight, at least 20-40 percent oxygen by weight, and at least 5 percent aluminum by weight. For example, some examples of the optical interposer 108 may include, e.g., at least 20-23 percent silicon and at least 20-26 percent oxygen by weight.

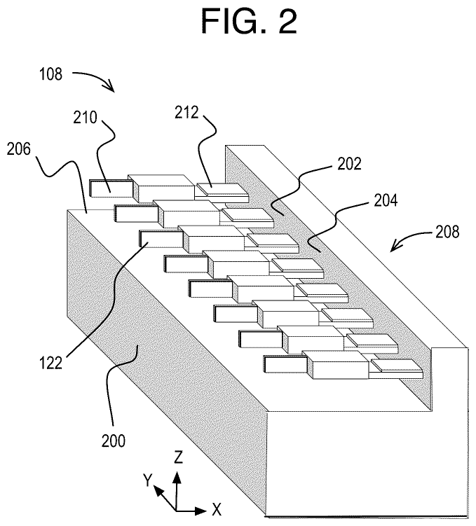

Referring to FIG. 2, the interposer 108 may have a body 200 with a recess 202 defined by a side or surface 204 of the body 200 and a floor 206 of the recess to provide space for an actuator beam array 208 of the actuator beams 122. By one form, multiple arrays 208, such as 1 to 64 arrays 208, may be provided, and each actuator array 208 may include two or more actuator beams 122, such as 2 to 64 beams 122. When multiple arrays 208 are present, the arrays 208 may be one above the other, side-by-side, or any other desired pattern. The actuator beams 122 cantilever outward from the side or surface 204 to extend to an adjacent optical component such as the PIC die 106 or another component. The actuator beams 122 extend over the recess floor 206 without contacting the floor 206. Thus, the array 208 may generally form a plane that is parallel to the floor 206. Each or individual beam 122 may have two actuators 210 and 212, each controlling bending of the beam in a different direction (horizontal or vertical for example), and as described in detail below. The actuator beam array 208 may have a range of pitches such as 10-100 microns, or 10 to 200 microns, and by one example form, 128 microns from beam to beam.

It also will be appreciated that the implementations herein will have the actuator beams extending in air. For some applications, however, such as satellite or space-based applications, a beam could be in a vacuum. Otherwise, a beam could be immerged in an index-matched liquid. The alignment between a PIC and an optical component with the beams may be adjusted during the package assembly based on the media being used between two components (e.g., air, helium, nitrogen, index-matched liquid, vacuum, and so forth).

Returning to FIG. 1A, circuitry (not shown) at the interposer 108 may be used to control the actuator beams and couple actuators 210 and 212 (FIG. 2) on the actuator beams 122 to a cable 118, such as a ribbon cable, and through solder balls or other conductive coupler. The cable 118 may have another end (not shown) coupled to the circuit board 101. Otherwise, the ribbon cable 118 may couple to another component, such as the substrate 102. In some examples, the ribbon cable 118 may couple to any of the PIC dies 106 or the EIC dies 104 or another EIC die, etc. The ribbon cable 118 may be communicatively coupled to control circuitry, e.g., through the substrate 102 to another component such as the EIC die 104 or another integrated circuit component or device. The control circuitry can control the actuator beams 122 to align the beam waveguides 128 to the P waveguides 120 on the PIC die 106 in this example. In another option, the actuators 210 and 212 may couple to a component other than a ribbon cable 118, such as directly to the substrate 102, directly to an EIC die 104, directly to the PIC die 106, and so forth.

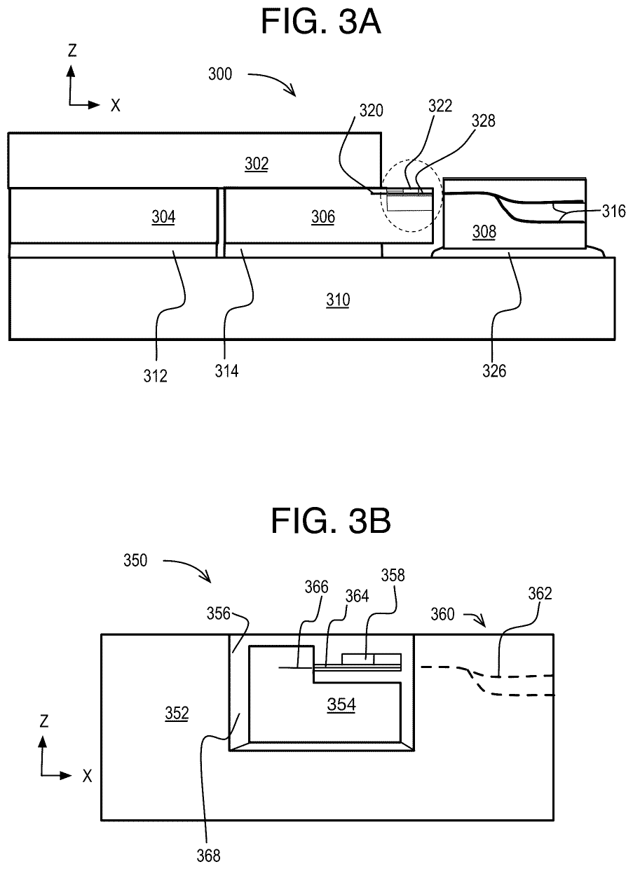

Referring to FIG. 3A, in other alternatives, the actuator beams may be provided on another optical component on a photonic package rather than the interposer. For example, a photonic IC package 300 has the same or similar components as package 100, and similar components are numbered similarly. In this case, however, a PIC die 306 has a side or surface with an array of actuator beams 322 extending outward from the side or surface. The actuator beams 322 may each or individually have a waveguide 328 that is aligned with (or is continuous with) a waveguide 320 within the PIC die 306. The beam waveguides 328 also may be aligned with a waveguide 316 in an interposer 308. Thus many different components on a photonic IC package can have the actuator beams extend toward another optical component on the package, and this may include PIC dies, EIC dies, interposers, FAUs, and so forth. The actuator beams 322 may be the same or similar to that shown in FIG. 2 except that a PIC die may be used instead of an interposer 108.

Referring to FIG. 3B for yet another approach, a substrate, or a portion of a substrate, can be considered an optical component that either faces the actuator beams or that has the actuator beams. For example, a package 350 has a substrate 352 and a PIC die 354 in a cavity 356 on the substrate 352. In this case, the PIC die 354 has actuator beams 358 with waveguides 364 that align with waveguides or optical paths 362 on the substrate 352 and waveguides 366 within, or on, the PIC die 354. The optical paths or waveguides 362 may be arranged in a fanned out array 360 to couple to an FAU external to the substrate or other optical components on package 350 or external to package 350.

By one alternative form, the substrate 352 (or portion of substrate 352) with waveguides 362 may not be sufficiently transparent or translucent to eliminate the waveguides. It should be noted that the terms optical, optic, and light are used interchangeably herein to generally refer to something relating to light, and the terms path and pathway are used interchangeably as well. When the substrate 352 is not transparent, it may include silicon with copper planes, or other known dielectrics with fillers. In various implementations, substrate 352 comprises a patterned glass. By one form, if bulk material of the substrate 352 is between upper and lower dielectric layers (not shown), the substrate 352 may be referred to as a substrate core if the dielectric layers are to be considered a part of the substrate 352.

When the substrate or substrate core 352 is photonic, the bulk material of the substrate 352 may be formed of a glass material, and the glass may be at least sufficiently transparent or translucent so that optical or light paths through the substrate can be established for fiber optic signal transmission without always using waveguides within or on the substrate. In this case, at least one or some of the light or optical paths, or portions thereof, within the substrate 352 can be established to project or propagate light through the bulk glass or other transparent or translucent material of the substrate 352. In this case, all or part of optical paths 362 may be provided without waveguides. The substrate 352 may comprise various types of transparent or translucent material, including fused silicon, borosilicate glass, or other glass materials such as transparent polymers.

More specifically, the glass of the substrate 352 may be aluminosilicate, borosilicate, alumino-borosilicate, silica, and/or fused silica. The glass may include additives such as Al2O3, B2O3, MgO, CaO, SrO, BaO, SnO2, Na2O, K2O, SrO, P2O3, ZrO2, Li2O, Ti, and Zn. The glass may comprise Silicon and Oxygen, as well as any one or more of Aluminum, Boron, Magnesium, Calcium, Barium, Tin, Sodium, Potassium, Strontium, Phosphorus, Zirconium, Lithium, Titanium, and Zinc. By one example form, the glass material of the substrate may have at least 23 percent Silicon and at least 26 percent Oxygen by weight, and may further comprise at least 5 percent Aluminum by weight.

The substrate 352 may be a glass core substrate, and by one example, where the glass core has a thickness in a range of about 50 um to 1.4 mm. By another form, a multi-layer glass substrate—e.g., a coreless substrate, may have a glass layer with a thickness in a range of about 25 um to 50 um. A glass core, glass layer, or substrate 352 may have dimensions of about 10 mm on a side to 250 mm on a side (e.g., 10 mm×10 mm to 250 mm×250 mm). Also, the glass core or glass layer may have a rectangular prism volume with sections (e.g., vias) removed and filled with other materials (e.g., metal).

The PIC die 354 also may be positioned within a cavity 356 with a transparent or translucent filler material 368 to hold the PIC die 354. This PIC filler material 368 may be index matching material such as infrared, ultraviolet (UV), and/or thermal curable optical material with a refractive index that may or may not match that of the substrate. Thus, a good anti-reflection coating between interfaces of different refractive index materials forming the material 368 and substrate may still function adequately, even when an air gap exists between the substrate and the PIC die 354. In various implementations, index matching material 368 may be an ester, acrylic, or epoxy. In implementations, index matching material 368 is applied in a way so as to prevent any air gaps between where the optical signal is output or detected and substrate 352.

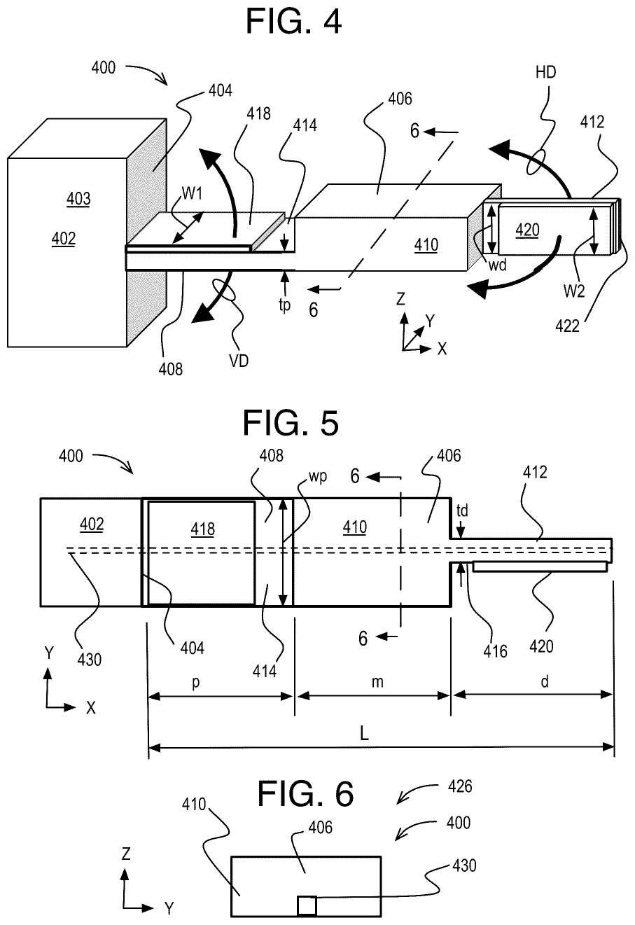

Referring to FIGS. 4-6, an example photonic IC package 400, similar or the same as package 100, has an actuator beam 406 supported by an optical component 402, such as an interposer, PIC die, FAU, substrate, or other optical component. The optical component 402 has a body 403, and the beam 406 is cantilevered from a side or surface (or side surface) 404 of the body 403. The beam 406 has a first or proximal portion 408 adjacent the side 404 but could be spaced from the side 404 along a length L of the beam 406. A second or distal portion 412 of the beam 406 forms a free distal end 422 of the beam 406, while a middle portion 410 interconnects the proximal and distal portions 408 and 412 to each other. By one form, the distal portion 412 is at least distal to the proximal portion 408 along the length L (FIG. 5) of the beam 406 and need not always extend to the free end 422 of the beam. Also optionally, the middle portion 410 may be omitted and the distal and proximal portions 408 and 410 may engage directly instead.

The proximal portion 408 may have, or be, a horizontal plate portion that extends horizontally, and by one form, parallel to a horizontal plane or surface 124 (FIG. 1) of the package substrate that faces the PIC die 106 (FIG. 1) for example. The horizontal plate portion 408 may have a rectangular or plate-shaped transverse cross-section where transverse is relative to the length L (or x-direction of the beam), and that is rectangular such that it has a small thickness (or here, height in the z-direction of the beam) denoted as tp and relative to a wider width wp in the y-direction of the beam. The horizontal plate portion 408 may be flexible to bend the beam vertically upward or downward as needed to align a waveguide 430 on the beam 406 with another waveguide as described above. An actuator 418 is on or over an upper surface 414 of the horizontal plate portion 408 to force the beam to bend upward or downward when activated as shown by the arrows VD. The beam 406 may be displaced by the actuator 418 upward or downward from the horizontal beam portion 408 to the distal free end 422 of the beam 406.

The distal portion 412 has, or may be, a vertical plate portion that extends vertically and also has a rectangular transverse cross-section relative to length L with a small thickness td and a width wd. The vertical plate portion 412 may be flexible to bend the beam horizontally left or right as needed to align the waveguide 430 on the beam 406 with another waveguide as described above. An actuator 420 is on or adjacent a side surface 416 of the vertical plate portion 412 to force the beam to bend left or right as shown by arrows HD when activated. The beam 406 may be displaced left and right by the actuator 420 and from a point on the vertical plate portion 412 to the distal free end 422 of the beam. The vertical displacement, originating from the proximal plate portion 408, results in displacing the actuator 420 up or down along with the vertical plate portion 412 so that horizontal displacement of the distal end 422 can occur at various displacement heights, thereby establishing a two dimensional range of displacement for the distal end 422 of the beam 406.

Also, it will be appreciated that while the plate thicknesses tp and td are described herein as being the same, such as 40 microns, or 10 to 40 microns, or 10 to 50 microns, the two thicknesses can be different and may be more precisely selected for specific bending strength needed for the proximal vertical bending versus the distal horizontal bending of the beam.

The horizontal plate portion is the proximal plate portion 408 in this example because it was determined that waveguide misalignment was caused more by substrate warpage that causes vertical displacement rather than the other misalignment sources that largely result in horizontal waveguide misalignment. Since the proximal plate portion 408 will provide larger displacements, the horizontal plate was placed at the proximal plate portion rather than at the distal plate portion.

The middle portion 410 may be solid, and in this example, has a rectangular transverse cross-section 426 (FIG. 6). The middle portion 410 may be solid to form a strong connection between the proximal and distal portions 408 and 412. In one form, the middle portion 410 may rise or fall with the intentional vertical displacement of the beam 406, but the middle portion 410 itself will not bend.

The actuators 418 and 420 may be a number of different transducers that convert electrical or other energy into kinetic energy to apply force to the plate portions 408 and 412, and cause them to move. By one form herein, the actuators 418 and 420 may be piezoelectric actuators with piezoelectric material such as lead zirconate titanate (PZT). The actuators 418 and 420 may be layered or deposited on the plate portions 408 and 412. By one form, the actuators 418 and 420 ideally have the same width and length of the plate portions 408 and 412 because the larger the area of the piezoelectric layer, the more displacement per volt that can be achieved thereby reducing power consumption. Otherwise, for fabrication, the width and length of the actuators 418 and 420 are smaller than that of the horizontal and vertical plate portions 408 and 412 in order to accommodate manufacturing tolerances.

By other alternatives, expandable polysilicon traces may be used instead or in addition to the piezoelectric actuators where the traces expand when current is applied, and the expansion of the traces pushes against the plate portions 408 and 412 causing them to move. Additionally or alternatively, the actuator beams 406 may actuate based on, e.g., electrostatic attraction, electromagnetic force, electrostriction, and so forth. Otherwise, the actuator beams 406 may be made of materials that can directly actuate.

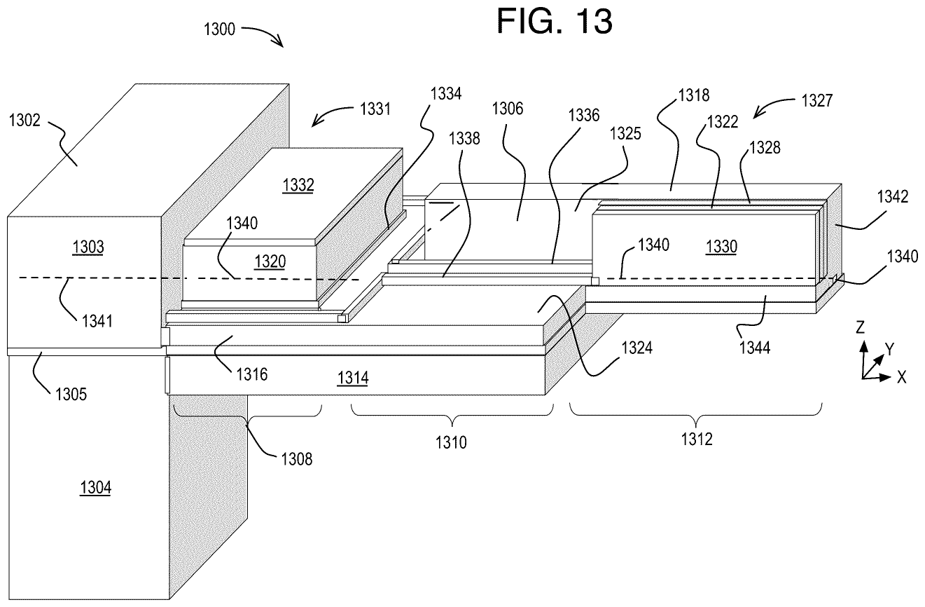

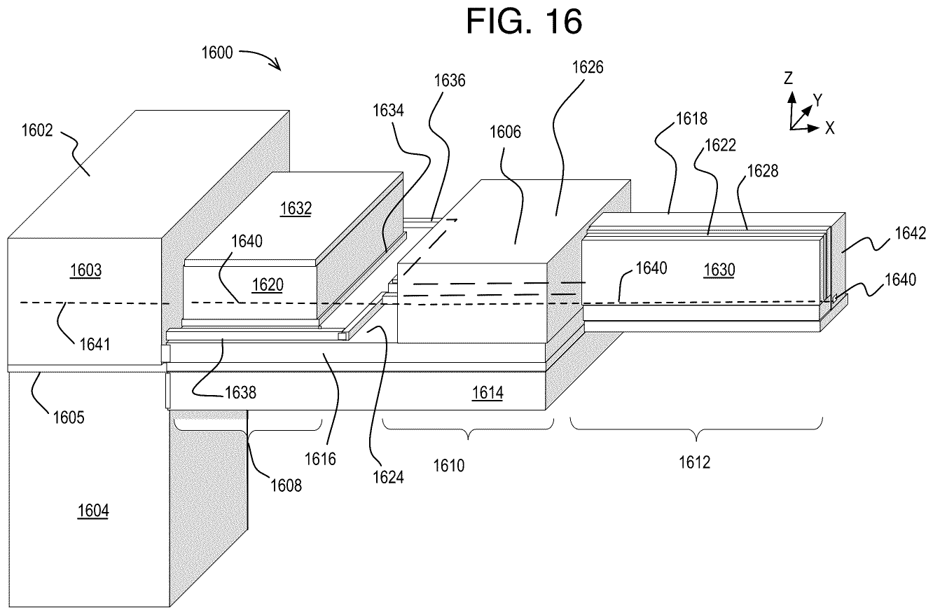

The beam 406 also has a waveguide 430 that extends along (or through or on) both the horizontal and the vertical plate portions 408 and 412. The waveguide 430 may be embedded partially or entirely within the bulk material of the beam 406. By one form as shown in FIG. 6, the waveguide 430 may be within a groove of the horizontal and vertical plate portions 408 and 412 at least at part of the length of the beam 406. The waveguide 430 may be entirely embedded depending on the configuration of the transverse cross-sections being used on the beam. The waveguide 430 also may have its bottom covered by a buried oxide (BOX) layer described below (FIGS. 13 and 16).

The material of the beam 406 shown here may be the same or similar to that used by the bulk material or layers of the optical component supporting the beam, such as a PIC die or interposer. Thus, by one example, the beam 406, and the portion of the optical component 402 supporting the beam 406 may be formed of silicon dioxide. Other details are provided below.

By one example arrangement, the total length L of the beam 406 may be 3 mm, the horizontal plate portion 408 has a length p of exactly or substantially 1.0 mm, while the vertical plate portion 412 has a length d of exactly or substantially 1.5 mm. It will be understood that these measurements refer to the proximal and distal portions and not any extensions of the plate portions 408 and 412 into the middle portion. Also, the actuator lengths may be the same or may be 100 microns shorter than the length of the plate portions 408 and 412 to compensate for manufacturing tolerances, and this applies equally to any of the implementations herein. In this example, the middle portion 410 may be exactly or substantially m=0.5 mm long. The width of the actuators W1 and W2 may be the same or smaller than the transverse widths wp and wd of the plate portions 408 and 412, and by one form is 80-100 microns depending on a pitch of a beam array with beam 406 so that the beams do not interfere with each other, and where here the pitch is at least 128 microns. In turn, the actuators 418 and 420 also may have widest transverse widths of 80-100 microns. Otherwise the available dimensions vary widely.

In an alternative, it will be appreciated that the proximal plate portion could have a vertical plate, and the distal plate portion could have a horizontal plate instead. This may require more voltage, however, because less beam displacement will occur in this case.

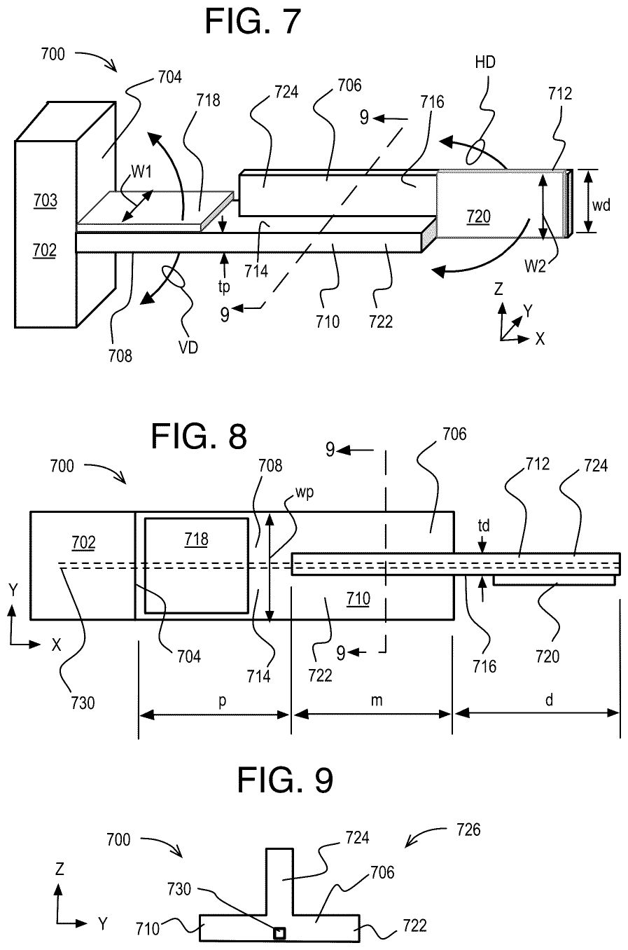

Referring to FIGS. 7-9, a package 700 has a number of the same or similar beam arrangements and components as package 400, and is numbered similarly and does not need to be described again. In this case, however, plate portions 708 and 712 are extended toward each so that a middle vertical plate portion 724 and a middle horizontal plate portion 722 intersect and overlap to cooperatively form an inverted T-shape cross-section 726 as shown on FIG. 9.

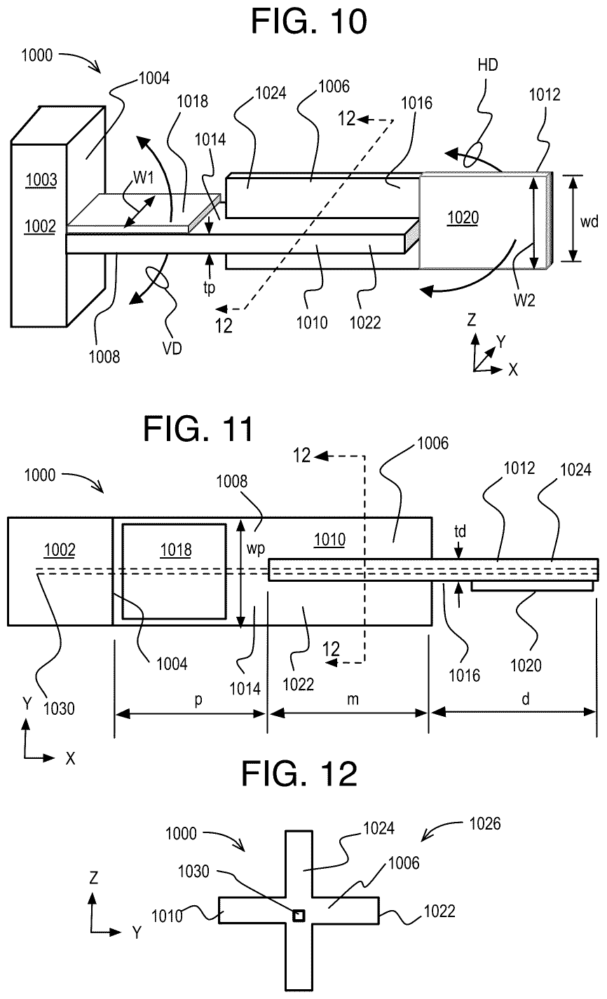

Referring to FIGS. 10-12, a package 1000 has a number of the same or similar beam arrangements and components as packages 400 and 700, and is numbered similarly and does not need to be described again. In this case, however, a vertical plate portion 1012 extends below and above a horizontal plate portion 1008, and the plate portions 1008 and 1012 extend toward each other so that a middle vertical plate portion 1024 and a middle horizontal plate portion 1022 intersect and overlap to cooperatively form a plus-shaped cross-section 1026 as shown on FIG. 9. In this case, the waveguide 1030 may be entirely embedded within the silicon dioxide material of the beam 406, or otherwise may be located at an outer surface of the plus-shaped cross section.

Referring to FIG. 13, an alternative package 1300 may be formed by (or compatible with) SOI fabrication by using package components with a silicon layer and a silicon dioxide layer as with package 100. Specifically, the alternative package 1300 has an optical component 1302, such as a PIC die or interposer for example (here an interposer example is being used), and that has a silicon dioxide (or oxide cladding) waveguide layer 1303 over a silicon interposer substrate layer 1304 of the optical component 1302 and with a BOX layer 1305 between the waveguide layer 1303 and the substrate layer 1304. The optical component 1302 supports a cantilevered actuator beam 1306. The waveguide layer 1303 may embed one or more waveguides 1341 to align with a waveguide 1340 of the beam 1306 and as described above with FIG. 1B. The actuator beam 1306 has a proximal portion 1308 that is, or has, a horizontal plate portion 1316, and a distal portion 1312 that is, or has, a vertical plate portion 1318. The horizontal and vertical plate portions 1316 and 1318 extend into a middle portion 1310 to cooperatively form an inverted T-shaped transverse cross-section as with package 700 (FIG. 9) above. The BOX layer 1305 may extend underneath the horizontal and vertical plate portions 1316 and 1318 in order to isolate the waveguide layer from the Silicon layer 1314.

In this example, the substrate layer 1304 also optionally may support a beam support 1314 that extends horizontally under the horizontal plate portion 1316. This may be used when the horizontal plate portion 1316 is too thin to provide sufficient bending and shear strength to hold up the components on the beam 1306. Specifically, Si has about twice the modulus or elasticity than SiO₂ so adding an Si support 1314 to the beam 1306 stiffens the beam 1306. However, the result is an increase in beam thickness such that a thicker piezoelectric actuator will be needed to vertically displace the beam 1306. Thus, ideally, the silicon dioxide layer should be maximized with as little of the Si support layer as possible.

The beam 1306 also has two actuator stacks 1327 and 1331, one on each of the plate portions 1316 and 1318. The horizontal plate portion stack 1331 is a vertical stack (stacked vertically) piled on an upper surface 1324 of the horizontal plate portion 1316 and has a piezoelectric actuator 1320 between two conductive features or pads 1332 and 1334, where the bottom pad 1334 may be placed directly on the upper surface 1324. The vertical plate portion stack 1327 is a horizontal stack (stacked horizontally) placed against a side surface 1325 of the vertical plate portion 1318 and has a piezoelectric actuator 1322 between two conductive features or pads 1328 and 1330. The pad 1328 is placed directly against the side surface 1325. The actuator 1322 and conductive pads 1328 and 1330 may extend to the distal free end 1342 of the beam 1306 or may terminate slightly short of the distal end 1342. The length and width of the actuator stacks 1327 and 1331 respectively may be the same or slightly smaller than the length of the distal and proximal portions and the width of the vertical and horizontal plates 1316 and 1318. By one form, Optionally, the distal plate portion 1318 also may include, or may be connected to, a horizontally extending shelf portion 1344 to assist with support of the distal actuator 1322 and conductive pads 1328 and 1330, although the shelf may be omitted when the actuator stack 1327 can sufficiently adhere to the distal plate portion 1318 without support.

The waveguide 1340 may extend along, on, or through the horizontal and vertical plate portions 1316 and 1318, and in this example in a bottom of the plate portions 1316 and 1318 so that the waveguide 1340 is on or over the BOX layer 1305.

Also in this example, metallization such as traces 1336 and 1338 extend on the surface 1324 and to conductively couple to the pads 1328 and 1330 to provide current to the actuator 1322 as needed. Other metallization or circuitry not shown may provide current to the pads 1332 and 1334, and in turn actuator 1320 as needed. Such metallization may extend from the traces 1336 and 1338 as well as the pads 1332 and 1334, and within the waveguide layer 1303 of the optical components 1302. The metallization then may lead to control (or drive) systems or circuits and power supply circuitry as described below herein. Any of the metallization mentioned may include one or more metallization layers with traces, caps, pads, interconnects, vias, and so forth, and in or on the components of package 1300 as described with package 100. The conductive features 1332, 1334, 1328, 1330 and metallization 1336, 1338 may be made of copper or other conductive metals or alloys. Otherwise, the materials of any of these elements or components are as described above if not mentioned here.

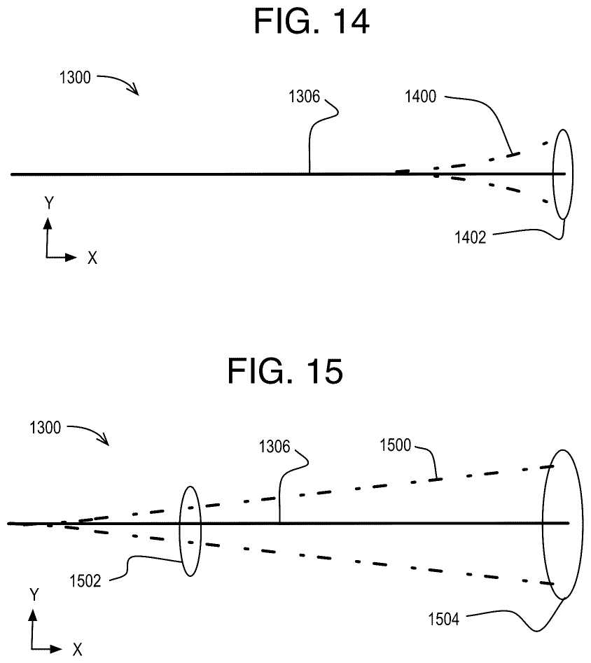

Referring to FIG. 14, a simplified representation of the package 1300 with a top view of the actuator beam 1306 is shown with an available range 1400 of side to side displacement 1402 of the a distal free end of the beam. The side to side displacement 1402 occurs from a point on the distal plate portion 1318 that has the actuator 1322 and to the end 1342 of the beam 1306.

Referring to FIG. 15, a simplified representation of the package 1300 with a side view of the actuator beam 1306 is shown with an available range 1500 of vertical displacement 1502 at a distal end of the horizontal plate portion 1308 (where the middle portion 1310 starts) and vertical displacement 1504 at the distal free end 1342 of the beam 1306. The vertical displacement 1502 and 1504 cooperatively occurs from a point on the proximal (or horizontal) plate portion 1308 that has the actuator 1320 and extending to the end 1342 of the beam 1306.

Referring to FIG. 16, another example package 1600 has an actuator beam 1606 that is similar to the actuator beam 1306 such that similar parts are numbered similarly and need not be described again, including metallization or traces 1636 and 1638 for the actuators' conductive pads 1628 and 1630. The exact routing of the traces 1636 and 1638 on the beam 1606 here may or may not be the same or similar than that on beam 1306 as shown on FIG. 16, and the traces on both beams 1306 and 1606 may have many different variations. For beam 1606, however, a middle portion 1610 of the actuator beam 1606 has the rectangular transverse cross-section as in FIGS. 4-6, and that also may be formed of silicon dioxide. The beam displacements 1402 and 1502 and 1504 of FIGS. 14-15 apply equally to package 1600 as well.

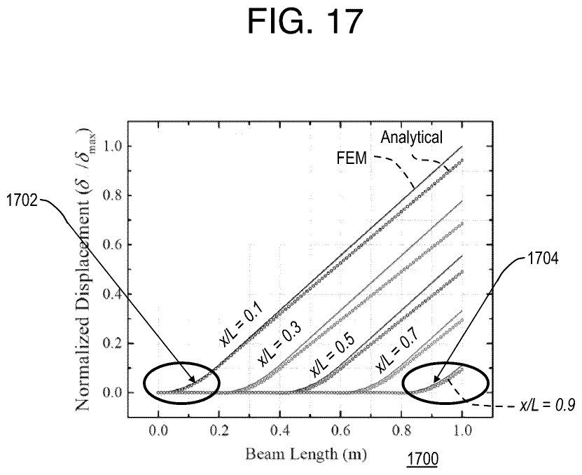

Referring to FIG. 17, a graph 1700 shows expected beam vertical displacement (normalized) of a right free distal end of a beam when a piezoelectric actuator is placed a distance x from a left proximal or support end of the beam and along a length L of the beam. The graph 1700 shows that a most proximal actuator at a position x/L=0.1 only has bending near the actuator at the proximal part of the beam and has the most displacement 1702, and a most distal actuator at a position x/L=0.9 only bends near the actuator near the distal end of the beam and has the least displacement 1704. These modeling results are shown as the available range of displacement (FIGS. 14-15). The structural modeling algorithms were followed from Aslam, Mohammad et al., “Numerical Studies on PZT-Bonded Aluminum Beam,” J. Inst. Eng. India Ser. A, 100(1):117-130 (March 2019).

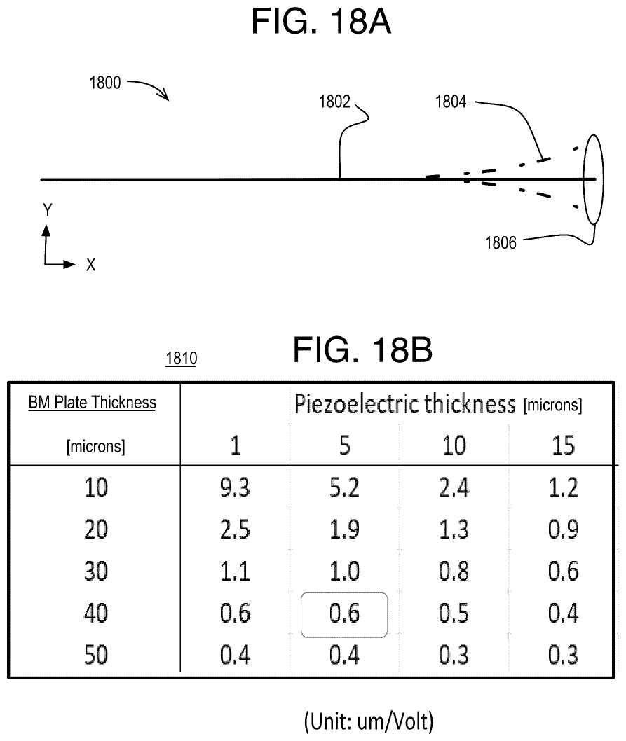

Referring to FIGS. 18A-18B, horizontal displacement per volt that can be obtained is shown on a table 1810 for various beam plate portion thicknesses (0 to 50 microns every 10 micron) and for different piezoelectric thicknesses (1, 5, 10, and 15 microns). A package 1800 was used with a two-dimensional actuator beam 1802 that has a side-to-side range 1804 of displacement 1806 at a distal free end of the beam. For this example, the beam 1802 has a total length of L=3 mm, and the proximal horizontal plate portion has a length of 1 mm where the proximal actuator at the horizontal plate portion may approach a length of p=1 mm (see FIG. 5 for example). The distal end portion or vertical plate portion has a length of d=1.5 mm while the distal actuator may have a length approaching 1.5 mm. The rigid or middle portion has a length m=0.5 mm. The actuator widths W1 and W2 (FIG. 4, 7, or 10) does not significantly impact the horizontal displacement. Thus, actuator widths W1 and W2 can be selected depending at least in part on the waveguide pitch so that the actuator beams in an array of the actuator beams do not interfere with each other either physically or by cross-talk. By one example mentioned above, W1 and W2 is to be 80-100 microns when the waveguide pitch from beam to beam in an actuator beam array is 128 microns. Also, the plate thicknesses may be 1 to 50 or 10 to 50 microns while the actuator thickness (not including the terminal plates) may be 1 to 15 microns.

Table 1810 shows that a horizontal displacement per volt can be obtained by selecting an actuator thickness and a thickness of the distal or vertical plate portion of the beam. For example, if the distal piezoelectric actuator thickness is to be 5 microns and the vertical plate portion thickness is to be 40 microns, the horizontal displacement at the distal end of the beam will be 0.6 microns/Volt. The displacement per volt was determined by using Chalvet, Vincent et al., “Static/Dynamic Trade-Off Performance of PZT Thick Film Micro-Actuators,” Journal of Micromechanics and Microengineering (July 2015).

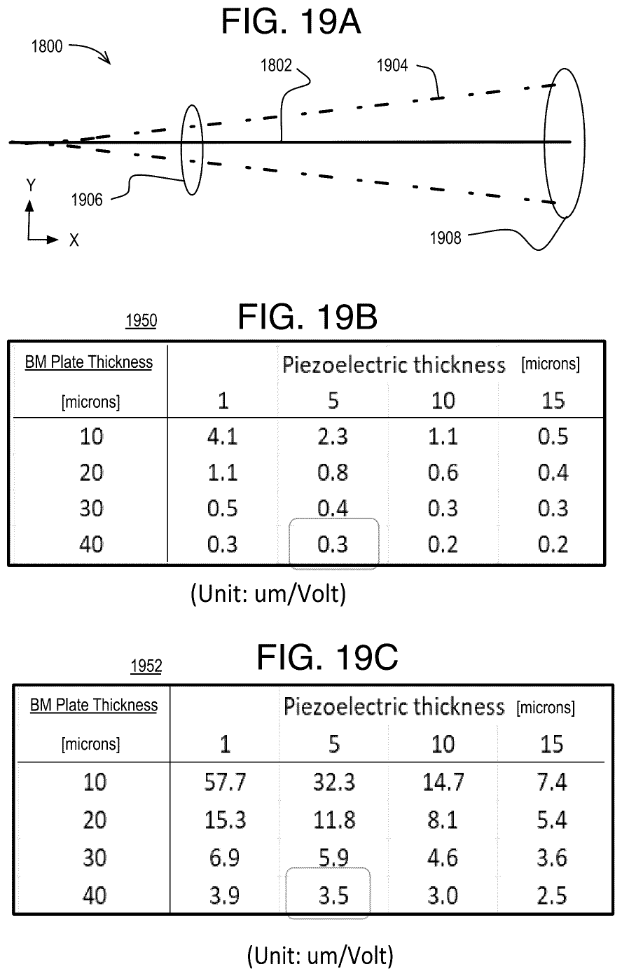

Referring to FIGS. 19A-19C, the same beam configuration and dimensions are used to determine the vertical displacement per volt. A side view of the actuator beam 1802 of package 1800 shows a vertical displacement range 1904 with vertical displacement 1906 measured at the point where the proximal and horizontal plate portion contacts the middle portion, and a vertical displacement 1908 at the distal free end of the beam 1802. A table 1950 shows the vertical displacement per volt at the displacement point 1906 and a table 1952 shows the vertical displacement per volt of the range 1908 at the distal end of the beam 1802. Both tables 1950 and 1952 show the displacement per volt depending on the thickness of the horizontal plate portion and the thickness of the piezoelectric actuator as with table 1810. For example, if the piezoelectric actuator has a thickness of 5 microns, and the thickness of the horizontal plate portion is 40 microns, then the vertical displacement at the locations 1906 and 1908 will be 0.3 and 3.5 microns/volt, respectively. Also in this example, the plate thicknesses may be 1 to 40 or 10 to 40 microns while the actuator thickness (not including the terminal plates) may be 1 to 15 microns.

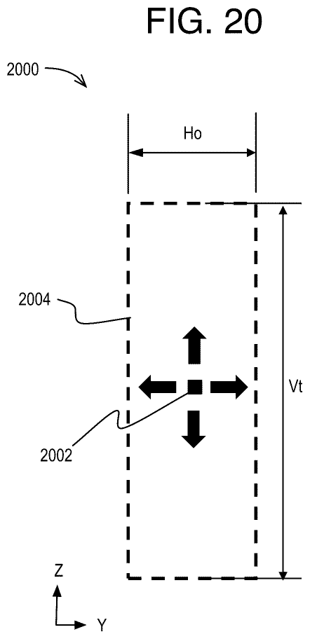

Referring to FIG. 20, an example two-dimensional waveguide displacement range 2000 shows two-dimensional displacement that can be achieved at the distal end of the actuator beam according to the results of the tables 1810 and 1952. A waveguide 2002 is shown with possible bending or motion arrows to an available 2D outer boundary 2004. The total horizontal width H of the range for +/−3 V at the distal piezoelectric actuator is Ho=3.6 microns for +/−1.9 microns (left or right). The total vertical range Vt that can be achieved is Vt=10.5 microns for +/−5.25 microns (up or down) when +/−1.5 V is applied to the proximal piezoelectric actuator. The larger vertical displacement Vt can be used to overcome large substrate warpage (e.g., 3-5 microns) in a package substrate or in a PIC. The smaller horizontal displacement Ho can be used to overcome offsets caused by passive alignment errors during assembly or the manufacturing tolerances in the waveguide pitch as mentioned above for example. By one form, the piezoelectric actuators can be operated below 1 mA, so that power consumption may be low for such a two-dimensional actuator beam shown in this example.

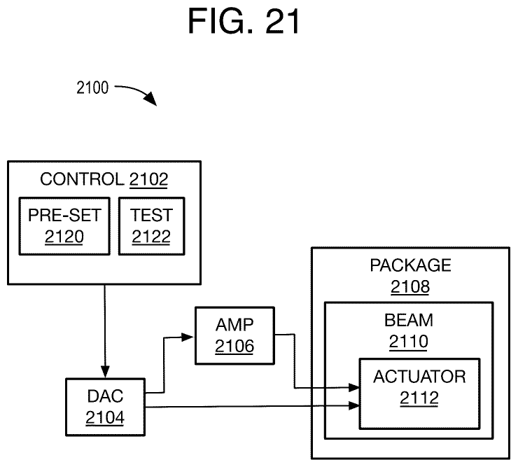

Referring to FIG. 21, many ways exist to drive the piezoelectric actuators and many different drive circuitry arrangements can be used. One example is a control or drive system or circuitry 2100 that has a control unit 2102 to drive an actuator 2112 on an actuator beam 2110 of an electronic photonic package 2108. It will be understood that each actuator 2112, including a distal and proximal actuator as described herein, may have a separate control circuitry 2100 or may share at least some of the units of a single control circuitry 2100. When an array of actuator beams 2110 are provided, each beam may have its own completely separate drive circuit or circuits, whether for one such circuit for each actuator or for a pair of the actuators for a single beam. Many variations are contemplated. The control circuitry 2100 also may include or be coupled to a digital to analog converter (DAC) 2104, and an amplifier unit 2106.

The control unit 2102 may have a pre-set unit 2120 to provide pre-set digital codes to the DAC 2104 and that indicate an amount of displacement to be obtained at an actuator beam 2112. By one form, the codes may be set within a range of 1 to 1024 (or 0 to 1023) for a 10 bit binary code, although many other examples exist. The control unit 2102 may have access to memory storing the codes. The control unit 2102 also may have a test unit 2122 that detects whether waveguides are misaligned and the amount of displacement needed to align waveguides on the actuator beam 2110 to waveguides on adjacent optical components as described above. Such a test unit 2122 may receive output from optical detectors or photodetector circuitry on the package 2108 that detects the waveguide alignment at or adjacent to the actuator beams 2110. Such optical detectors may include photodiodes, position-sensitive detectors (PSDs), charge-coupled devices (CCDs), avalanche photodiodes (APDs), interferometric sensors, and/or micro-electro-mechanical systems (MEMS) fabrication-based devices such as phototransistors, bolometers, thermal detectors, and/or grating-based detectors, and so forth.

The DAC 2104 may convert the digital code from the control unit 2102 to a voltage level that then may be applied to the actuator 2112, here being a piezoelectric actuator. In this case, the DAC 2104 itself may have the circuitry (or be electrically coupled to such circuitry), such as resistors, switch transistors, traces, and other metallization, and so forth, to adjust the supply voltages of electricity received from an electrical supply circuit. By one example form, this may be a current of 1 mA.

By one form, the DAC 2104, the amplifier 2106, or another voltage level monitoring unit or circuit monitors the voltage level produced by the DAC. Then, if the voltage level is not sufficient for driving the actuator for a displacement range, or the DAC 2104 does not have enough drive capability to drive the actuator, an amplifier 2106, such as a single transistor amplifier for example, can be used to enlarge the voltage range that can be applied to the actuator 2112, and this can be provided for individual actuators on a beam as mentioned above. In this case, and instead of the DAC 2104, such an amplifier 2106 may have the drive circuitry to adjust the electricity from a power supply circuit as mentioned above for the DAC 2104. By one form, the same circuit 2100 can be used for multiple actuators 2112 if a number of beams 2110 are to be set to have the same displacement. Otherwise, the DAC 2104 can be shared by multiple actuators 2112, but where each actuator 2112 still has its own amplifier 2106.

It will be understood that the control circuitry 2100 may be formed of any combination of software, hardware, or firmware, and may have all hardware and firmware components on the same electronic package as the actuator beams, except for operative coupling to a power supply. Otherwise, one or more components of the drive circuitry 2100 may be on a number of different electronic devices either physically or communicatively coupled to each other, and may include having remote components. In some forms, the control circuitry 2100 may be embodied in an EIC die, such as the EIC die 104. The control circuitry 2100 may be embodied as a processor, memory, a program stored in memory and executed by the processor, dedicated hardware circuitry for controlling the actuator beams 2110, a proportional-integral-differential (PID) controller, and/or the like.

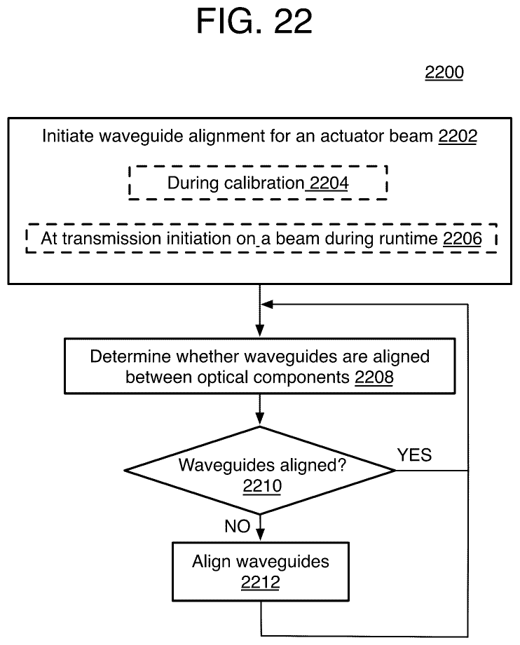

Referring to FIG. 22, an example method of aligning waveguides on two different optical components of a photonic package, such as a PIC and interposer, may be performed according to at least one of the implementations disclosed herein and is described with operations 2202 to 2206 generally numbered evenly. Process 2200 may be executed by control circuitry 2100 or other suitable circuitry, although any of the electronic photonic systems, devices, circuitry, and/or packages of the various implementations in FIGS. 1-21 and 23-25 may be referred to herein where appropriate.

Process 2200 may include “initiate waveguide alignment for an actuator beam” 2202, and this may refer to initiation for all or individual actuator beams in an actuator beam array on an optical component. This may be performed during manufacturing or calibration 2204 of the function of the actuator beams to achieve waveguide alignment and to determine initial displacement codes (and in turn voltage levels) to set for each actuator of at least one actuator beam. By one form, all beams are activated during manufacturing or calibration. By one alternative, the waveguide alignment process 2200 may be performed to align the waveguides during calibration, and then the actuator beams may be fixed in place in an aligned state using epoxy or other solid filler. By another alternative, an open system may be used so that process 2200 calibrates for at least sufficient waveguide alignment, and pre-set displacement amount codes and/or voltage levels may be generated and stored to be used to align the actuator beams later during a runtime. In this case, alignment detection may not need to be performed later during runtime, and the alignment is performed directly using the pre-set values.

By yet another alternative, a closed system may be used where process 2200 will be performed each time, or particular times, a light transmission at the optical components is to be initiated 2206. This refers to performing both a waveguide alignment detection and measurement, and then waveguide alignment as needed during a runtime. In one example, the method 2200 may be performed continuously or continually while a device with the optical components with the actuator beams is being powered on. By another option, the method 2200 is performed during and continuously after being powered on. In another example, the method 2200 also (or only) may be performed after a detected change of environment, such as a temperature change, a vibration, or a mechanical shock that is detected by various internal or external sensors.

Thus, if a channel (or beam) is not being used in a device, the unused beams will not be aligned. For example, where 50 beams in 50 channels are provided, but only 25 channels are being used, only those 25 beams being used will be aligned by process 2200. By one form, the actuator beams each will revert back to a neutral position, which is typically straight when the power supply to the actuators on the beams is off, so that each beam should be re-aligned when a beam is subsequently turned on in a channel that is to be used for another light transmission.

The process 2200 may include “determine whether waveguides are aligned between optical components” 2208. Here, control circuitry 2100 may determine whether the waveguides in the actuator beams, on an interposer for example, are aligned to waveguides in an adjacent optical component such as a PIC die. The control circuitry may, for example, determine an amount of transmission loss when coupling between the waveguides, such as by using an active signal or a test signal. This may be determined by using photodetectors (or other optical detector as mentioned above) to measure the light intensity in each channel on the receiving side and provide feedback to the control unit 2102.

Next, process 2200 may include the inquiry “waveguides aligned?” 2210. If the waveguides being tested are aligned, then the beam and waveguide do not need realignment by the actuators. Thus, in this case, the method 2200 loops back to operation 2208 to recheck whether the waveguides are aligned at some time interval, or may be continuous or triggered as mentioned above, and this may be repeated at each beam being tested.

If the waveguides are not aligned, the process 2200 proceeds to “align waveguides” 2212. Thus, by one form, the control unit 2102 then may convert the transmission loss measurement into displacement amount codes, such as 1 to 1024, that indicate how much beam displacement should be needed to align the waveguides on the interposer and PIC. The code than may be stored whether for future waveguide alignment when the detection is not performed on-the-fly during a runtime, or stored for the short term (as in cache) when used immediately for on-the-fly operation during a runtime.

The control circuitry 2100 then may apply an alignment voltage to the actuators of a beam to align the waveguides. As with the initial waveguide alignment detection, the control circuitry 2100 may use an optical signal or transmission loss signal as feedback while aligning the waveguides. In some forms, the waveguides may not have sufficient coupling for an optical signal to be used as feedback. In this case, the control circuitry may perform a one-or two-dimensional search to find an optical signal to optimize on.

In one example, the alignment is performed by using active alignment. For this technique, x and y movement control is equivalent to voltage control at the vertical and horizontal piezoelectric actuators. In active alignment, both the x and y directions are adjusted simultaneously, following an algorithm such as a gradient search routine or other such algorithms for example, and until a peak distribution of sufficient alignment is achieved. When initiated, the active alignment algorithms may be used to simultaneously execute precise and frequent motions of a beam to measure the waveguide alignment at each tested beam position.

Otherwise, a step-by step trial and error process may be used instead. For example, one of the horizontal or vertical displacement actuators (a first actuator) may be set at a certain initial voltage, and then voltages are varied through an available range of voltages for the other (second) actuator on the same beam. Then, the process includes incrementing the voltage at the first actuator, and re-testing the second actuator for the range of available voltages until a sufficient waveguide alignment is detected. After waveguide alignment, the method 2200 loops back to operation 2208.

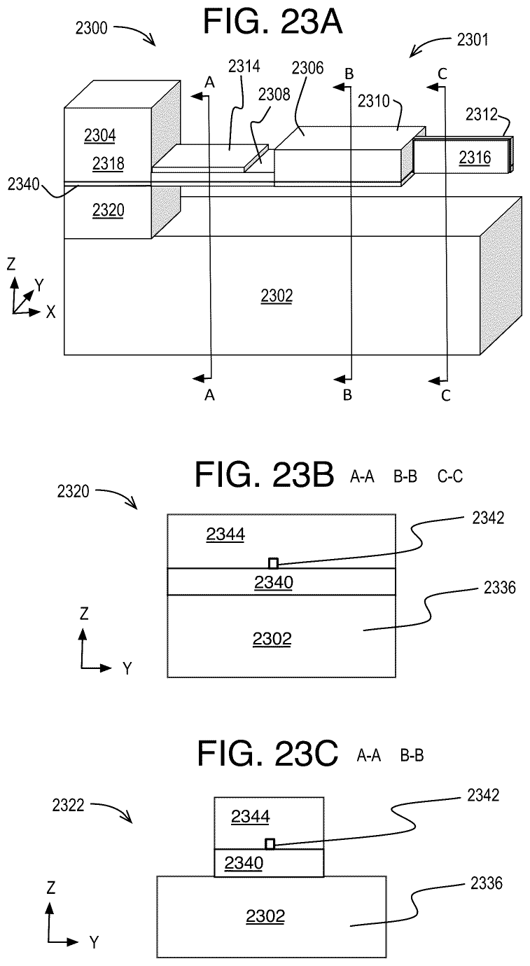

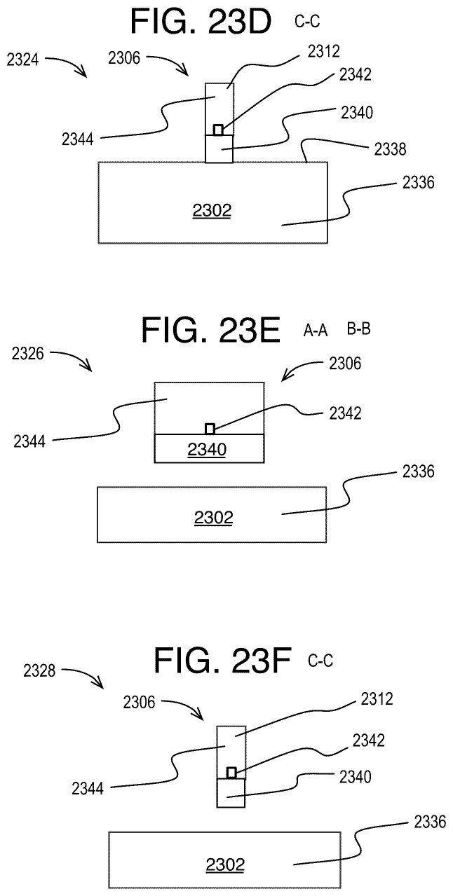

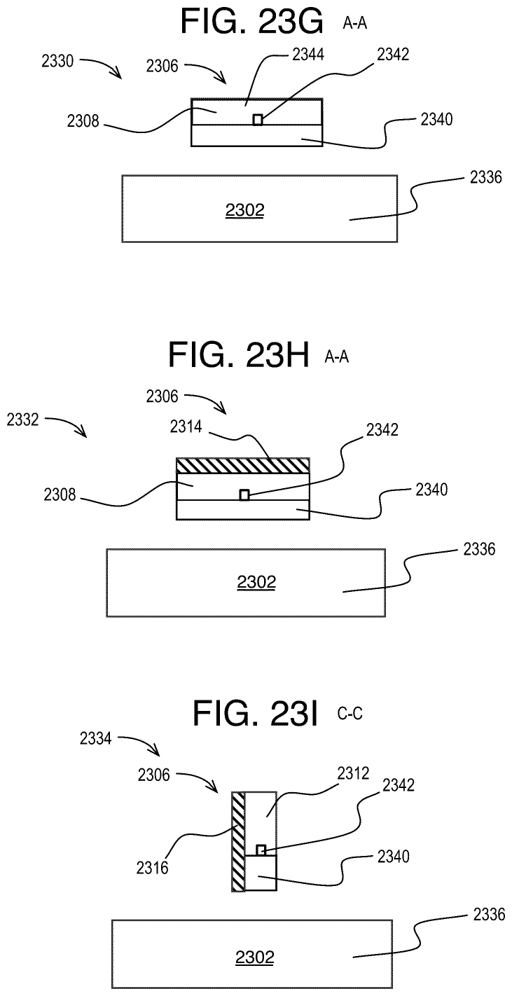

Referring to FIGS. 23A-23D, assembly stages 2320-2334 numbered evenly for assembly of an actuator beam are described herein. The assembly may use a micro-electronic mechanical systems (MEMS) process or operation.

Referring to FIG. 23A, a package 2300 may be used to explain the assembly in stages 2320 to 2334. Package 2300 has an optical component 2301, here being an interposer in this example. The interposer 2301 may have an interposer substrate 2302 supporting an interposer body 2304 with a silicon dioxide (or oxide cladding) waveguide layer 2318 over a BOX layer 2322, which in turn is over a silicon layer 2320. An actuator beam 2306 is cantilevered from the silicon dioxide layer 2318 and may be formed of silicon dioxide in this example. The beam 2306 has a proximal horizontal portion 2308, a middle portion 2310, and a distal portion 2312. A proximal actuator 2314 is adjacent the proximal portion 2308, and a distal actuator 2316 is adjacent the distal portion 2312. In this example, the proximal portion 2308 has a horizontal plate shape so that the proximal actuator 2314 controls vertical displacement of the beam 2306, while the distal portion 2312 has a vertical plate shape so that distal actuator 2316 controls horizontal displacement of the beam 2306. The middle portion 2310 has the rectangular shape as in FIGS. 4-6. Three cross-sections A-A, B-B, and C-C respectively at the proximal, middle, and distal portions 2308, 2310, 2312 are shown in various stages in stages 2320 and 2334 (FIGS. 23B to 23I).

Referring to FIG. 23B, an assembly stage 2320 shows an interposer 2336 either as part of an interposer wafer of multiple interposer components or dies, or already singulated from the wafer. The interposer wafer 2336 may have the interposer substrate 2302 of Si for example, the BOX layer 2340 over the substrate 2302, and a silicon dioxide layer 2344 on the BOX layer 2340. The silicon dioxide layer 2344 may be deposited over one or more waveguides, but here being one pre-formed waveguide 2342 on the BOX layer 2340, and formed of the materials mentioned above. The waveguide 2342 may be part of a parallel array of the waveguides on multiple actuator beams to be formed on the interposer 2336 (or 2301 as completed). By one example form, the BOX layer is 2 microns thick, and the Silicon dioxide layer is 5-10 microns thick, although many other dimensions may be used.

Referring to FIG. 23C in an assembly stage 2322, etching may be used to reduce the silicon dioxide and BOX layers 2344 and 2340 to the desired outer width of the beam 2306 at sections A-A and B-B (the proximal, horizontal plate portion 2308 and middle portion 2310 of the beam 2306). This may be include performing anisotropic etching (e.g., deep reactive ion etching, (DRIE)) or other types of etching. This may involve positive masking by an appropriate photoresist material over the beam portion of the layers to be maintained.

Referring to FIG. 23D, an assembly stage 2324 shows the etching at the distal portion (section C-C) to achieve the desired thickness of the vertical plate shape of the distal portion 2312, and may be performed with the same etching as with stage 2322. This may be the same operation simultaneously with stage 2322 where the masks are stepped (in top view, not shown) to etch the layers at the two different beam widths at the same time. The thickness td of the vertical plate is mentioned above (FIG. 4).

Referring to FIGS. 23E and 23F, assembly stages 2326 and 2328 use etching to lower a top 2338 (FIG. 23D) of the interposer substrate 2302 and to generate an undercut under the BOX layer 2340 that separates the beam 2306 from the interposer substrate 2302. This results in cantilevering beam 2306 from the body 2304 of the interposer 2301. The etching of the Si and creating the undercut may be performed by using wet etching, such as isotropic etching. By one example, the undercut may have a height of 10 to 100 micro meter.

It should be noted that in the present example, none of the silicon layer 2320 is maintained to form a bottom of the beam 2306 in this example. Alternatively, a bottom silicon layer may be maintained on a bottom of beam 2306, as in FIGS. 13 and 16, if a thicker beam is desired when the silicon dioxide and BOX layers 2344 and 2340 are too thin to provide sufficient bending and shear strength.

Referring to FIG. 23G, an assembly stage 2330 has a top of the silicon dioxide layer 2344 etched downward to a desired thickness tp (FIG. 4) of the horizontal plate at the proximal portion 2308. This may be performed by wet, anisotropic, or DRIE etching as well.

Referring to FIG. 23H, an assembly stage 2332 shows an actuator 2314 was deposited on the proximal portion 2308. This may be performed by first depositing a sacrificial layer, masking and exposing the proximal portion 2308, depositing the actuator material such as PZT and copper conductive terminal plates on opposite side of the PZT for a piezoelectric actuator in the resulting opening in the sacrificial layer, and then removing the sacrificial layer.

Referring to FIG. 23I, a stage 2334 has a similar deposition process as stage 2332 except now for the distal actuator 2316. In this case, a sacrificial layer may be used to form a deep cavity adjacent the vertical plate of the distal portion 2312 which is filled with the actuator material. The cavity may be widened by etching for each of the actuator layers to be deposited in the cavity, here being a layer of a conductive terminal such as copper, then PZT, and then another copper conductive terminal layer (shown in FIG. 13 for example), to be deposited in the cavity. The completed beam 2306 is shown in FIG. 23A.

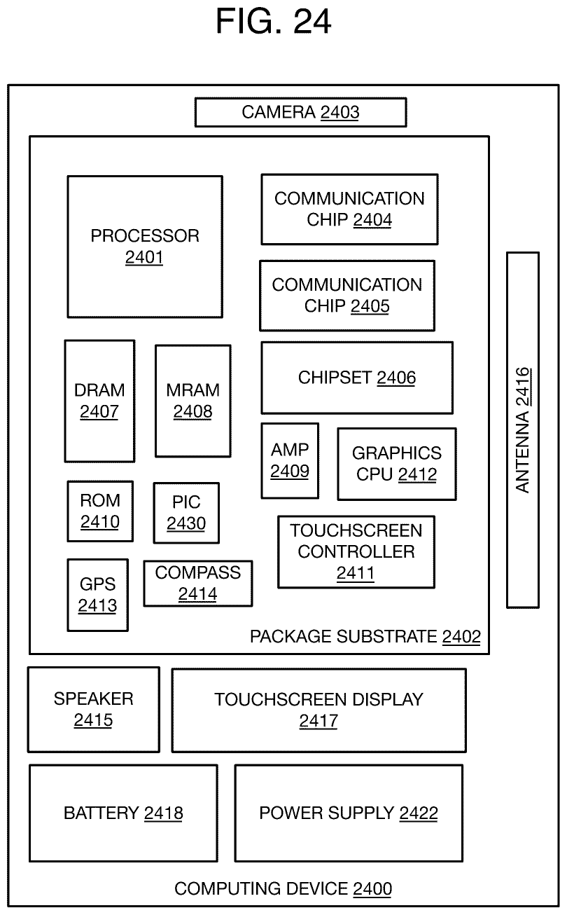

Referring to FIG. 24, a functional block diagram of an electronic computing device 2400 is provided in accordance with at least one implementation herein. Device 2400 further includes a package substrate 2402 hosting a number of components, such as, but not limited to, a processor 2401 (e.g., an applications processor). In implementations, device 2400 also may include at least one PIC 2430 on the substrate 2402 as well as other electronic optical components including interposers, FAUs, and so forth where at least one of the optical components has actuator beams as described elsewhere herein. Processor 2401 may be physically and/or electrically coupled to package substrate 2402. In some examples, processor 2401 is within a composite IC chip structure including a chiplet bonded to a host IC chip, for example. Processor 2401 may be implemented with circuitry in either or both of the host IC chip and chiplet. In general, the term “processor” or “microprocessor” may refer to any device or portion of a device that processes electronic data from registers and/or memory to transform that electronic data into other electronic data that may be further stored in registers and/or memory.

In various examples, one or more communication chips 2404 and 2405 also may be physically and/or electrically coupled to the package substrate 2402. In further implementations, communication chips 2404 and 2405 may be part of processor 2401. Depending on its applications, computing device 2400 may include other components that may or may not be physically and electrically coupled to package substrate 2402. These other components include, but are not limited to, volatile memory (e.g., DRAM 2407), non-volatile memory (e.g., ROM 2410), flash memory (e.g., NAND or NOR), magnetic memory (MRAM 2408), a graphics processor (CPU) 2412, a digital signal processor, a crypto processor, a chipset 2406, an antenna 2416, touchscreen display 2417, touchscreen controller 2411, battery unit 2418, audio codec, video codec, power amplifier 2409, global positioning system (GPS) device 2413, compass 2414, accelerometer, gyroscope, speaker 2415, camera 2403, and mass storage device (such as hard disk drive, solid-state drive (SSD), compact disk (CD), digital versatile disk (DVD), and so forth), and a power supply unit 2422, or the like. In some exemplary implementations, at least two of the functional blocks noted above are, or have, optical components that communicate via actuator beams described herein, for example. For example, processor 2401 may be implemented with circuitry in one or more of the optical components or dies electrically or communicatively coupled to those components. By one example, at least one of the blocks has a first host IC chip and chiplet, and an electronic memory (e.g., MRAM 2408 or DRAM 2407) that may be implemented with circuitry in a second of the host IC chip and chiplet.

Communication chips 2404 and 2405 may enable wireless communications for the transfer of data to and from the computing device 2400. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some implementations they might not. Communication chips 2404 and 2405 may implement any of a number of wireless standards or protocols. For example, a first communication chip 2404 may be dedicated to shorter-range wireless communications, such as Wi-Fi and Bluetooth, and a second communication chip 2405 may be dedicated to longer-range wireless communications such as GPS, EDGE, GPRS, CDMA, WiMAX, LTE, Ev-DO, and others.

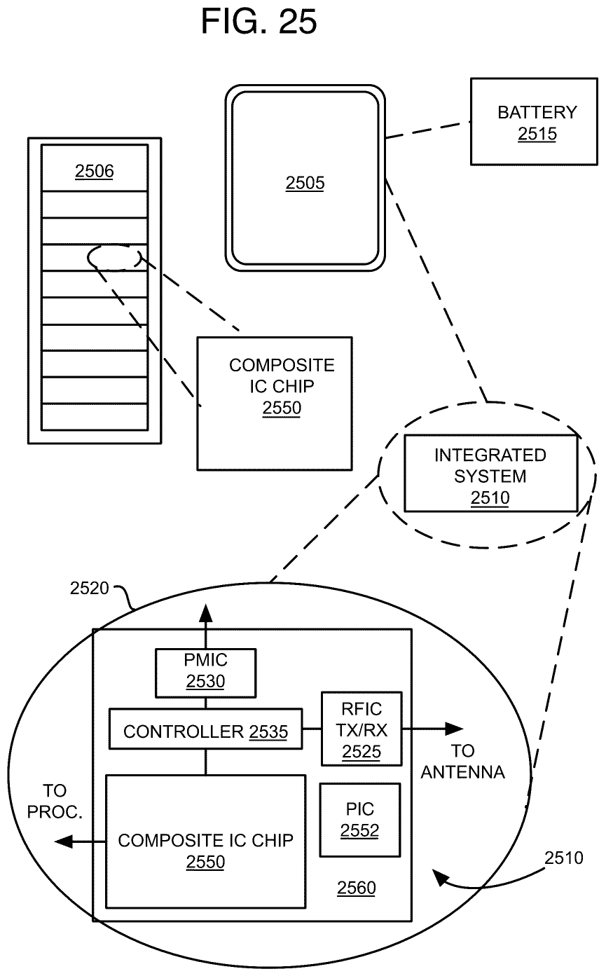

Referring to FIG. 25, a mobile computing platform 2505 and a data server machine 2506 employing an IC device comprises optical components such as at least one PIC 2552 and/or at least one interposer included in a photonic package with a substrate 2560 as described elsewhere herein. Computing device 2400 may be found inside platform 2505 or server machine 2506, for example. The server machine 2506 may be any commercial server, for example including any number of high-performance computing platforms disposed within a rack and networked together for electronic data processing, which in the exemplary implementation includes at least one PIC 2552 included in a package and being communicatively coupled to another optical component via actuator beams, for example as described elsewhere herein. The mobile computing platform 2505 may be any portable device configured for each of electronic data display, electronic data processing, wireless electronic data transmission, or the like. For example, the mobile computing platform 2505 may be any of a tablet, a smart phone, laptop computer, etc., and may include a display screen (e.g., a capacitive, inductive, resistive, or optical touchscreen), a chip-level or package-level integrated system 2510, and a battery 2515.

Whether disposed within the integrated system 2510 illustrated in the expanded view 2520, or as a stand-alone package within the server machine 2506, composite IC chip 2550 may include beam actuators and may use one or more chiplets, for example as described elsewhere herein. Composite IC chip 2550 may be further coupled to a host substrate 2560 comprising a PIC 2552, an FAU socket, and one or more actuator beams on one or more optical components as described elsewhere herein, one or more of a power management integrated circuit (PMIC) 2530, RF (wireless) integrated circuit (RFIC) 2525 including a wideband RF (wireless) transmitter and/or receiver (TX/RX) (e.g., including a digital baseband and an analog front end module further comprises a power amplifier on a transmit path and a low noise amplifier on a receive path), and a controller 2535. PMIC 2530 may perform battery power regulation, DC-to-DC conversion, etc., and so has an input coupled to battery 2515 and with an output providing a current supply to other functional modules. As further illustrated, in the exemplary implementation, RFIC 2525 has an output coupled to an antenna (not shown) to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond.

It is understood that the subject matter of the present description is not necessarily limited to specific applications illustrated in FIGS. 1-25. The subject matter may be applied to other microelectronic photonic devices and assembly applications, as well as any appropriate electronic application, as will be understood to those skilled in the art.

### EXAMPLES

The following examples pertain to further implementations. Specifics in the examples may be used anywhere in one or more implementations.

In example 1: an apparatus comprises an integrated circuit (IC) package substrate; a photonic integrated circuit (PIC) die over or under the IC package substrate and comprising a first waveguide; an optical component adjacent the PIC die and comprising an optical path; and a beam cantilevered from a surface of the PIC die or the optical component, the beam comprising a second waveguide between the first waveguide and the optical path, wherein the beam comprises a first plate portion extending in a horizontal or vertical plane, and a second plate portion distal from the first plate portion along a length of the beam and extending transversely to the first plate portion, wherein the second waveguide extends along both the first and second plate portions.

In example 2: the apparatus of example 1, comprising two actuators, wherein each actuator is adjacent a different one of the first and second plate portions.

In example 3: the apparatus of example 2, wherein the actuators are both piezoelectric.

In example 4: the apparatus of example 2 or 3, wherein the actuators have transducing material comprising lead zirconate titanate (PZT).

In example 5: the apparatus of example 2, 3, or 4, wherein the first plate portion is 1.0 mm along the length of the beam and the second plate portion is 1.5 mm along the length of the beam, and the two actuators respectively are the same length as the first and second plate portions or shorter by at most 100 microns.

In example 6: the apparatus of any one of examples 2 to 5, comprising an array of the beams arranged in parallel, and wherein both of the first and second plate portions and the two actuators have a transverse widest width of 80 to 100 microns and a pitch of the beams is 128 microns.

In example 7: the apparatus of any one of examples 2 to 6, wherein the actuators cooperatively provide a two-dimensional range of motion of a distal free end of the beam that is plus/minus 1.9 microns horizontally and +/−5.25 microns vertically.

In example 8: the apparatus of any one of examples 1 to 7, wherein the first and second plate portions have a thickness of 40 microns.

In example 9: the apparatus of any one of examples 1 to 8, wherein the IC package substrate comprises a horizontal surface facing and adjacent the PIC die, and wherein the first plate portion extends horizontally and parallel to the surface in a non-activated state.

In example 10: the apparatus of example 9, wherein the second plate portion extends vertically.

In example 11: the apparatus of example 9, comprising an array of the beams horizontally spaced from each other and each beam extending horizontally relative to the surface in a non-activated state.

In example 12: the apparatus of any one of examples 1 to 11, wherein the optical component is one of: another PIC die wherein the optical path comprises one or more waveguides, an optical interposer wherein the optical path comprises one or more waveguides, or a portion of the package substrate having the optical path in proximity to the second waveguide.

In example 13: an apparatus comprises an integrated circuit (IC) package substrate; a photonic integrated circuit (PIC) die over or under the IC package substrate and comprising at least one first waveguide; an optical component adjacent the PIC die and comprising at least one second waveguide; and at least one beam cantilevered from the PIC die or optical component and having a free distal end and a third waveguide extending along a length of the beam and between one of the first waveguides and one of the second waveguides, wherein the individual beams comprise a first portion having a first transverse cross-section with a horizontally extending plate-shape, a second portion distal to the first portion on the beam and having a second traverse cross-section with a vertically extending plate shape, and wherein the third waveguide extends through the first and second portions.

In example 14: the apparatus of example 13, wherein the beam comprises a rigid middle portion intersecting the first and second portions.

In example 15: the apparatus of example 14, wherein the middle portion has a transverse cross-section relative to the length that is rectangular, a plus-shape, or an inverted T-shape.

In example 16: the apparatus of any one of examples 13 to 15, comprising two actuators, each actuator being adjacent one of the first and second portions and having a piezoelectric material, and wherein the piezoelectric material has a thickness of 1-15 microns, and wherein the thickness of the first and second portions is 10-50 microns.

In example 17: a system comprises a package substrate; a photonic integrated circuit (PIC) die comprising a plurality of first waveguides; and an optical interposer comprising: a body, a plurality of second waveguides in the optical interposer, and an array of beams cantilevered from the body, wherein individual ones of the beams have a third waveguide positioned between one of the first waveguides and one of the second waveguides, and wherein individual ones of the beams comprise a first plate portion extending in a horizontal or vertical plane, and a second plate portion distal from the first plate portion along a length of the beam and extending transversely to the first plate portion, wherein the first and second plate portions have transverse cross-sections relative to the length that have a plate-shape, and wherein the third waveguide extends along both the first and second plate portions.

In example 18: the system of example 17, comprising two actuators, each actuator being adjacent a different one of the first and second plate portions and having a piezoelectric material.

In example 19: the system of example 18, comprising a control circuit electrically coupled to the actuators and providing 3.5 microns vertical displacement per volt and 0.6 microns horizontal displacement per volt at a free distal end of the beam when the first and second portions are 40 microns thick and the actuators are 5 microns thick.

In example 20: the system of example 18, comprising a pair of actuator stacks each having a first conductive feature on a different one of the first and second plate portions, one of the actuators each on one of the first conductive features, and a second conductive feature on each of the actuators.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

What is claimed is:

1. An apparatus, comprising:
an integrated circuit (IC) package substrate;
a photonic integrated circuit (PIC) die over or under the IC package substrate and comprising a first waveguide;
an optical component adjacent the PIC die and comprising an optical path; and
a beam cantilevered from a surface of the PIC die or the optical component, the beam comprising a second waveguide between the first waveguide and the optical path,
wherein the beam comprises a first plate portion extending in a horizontal or vertical plane, and a second plate portion distal from the first plate portion along a length of the beam and extending transversely to the first plate portion, wherein the second waveguide extends along both the first and second plate portions.

2. The apparatus of claim 1, comprising two actuators, wherein each actuator is adjacent a different one of the first and second plate portions.

3. The apparatus of claim 2, wherein the actuators are both piezoelectric.

4. The apparatus of claim 2, wherein the actuators have transducing material comprising lead zirconate titanate (PZT).

5. The apparatus of claim 2, wherein the first plate portion is 1.0 mm along the length of the beam and the second plate portion is 1.5 mm along the length of the beam, and the two actuators respectively are the same length as the first and second plate portions or shorter by at most 100 microns.

6. The apparatus of claim 2, comprising an array of the beams arranged in parallel, and wherein both of the first and second plate portions and the two actuators have a transverse widest width of 80 to 100 microns and a pitch of the beams is 128 microns.

7. The apparatus of claim 2, wherein the actuators cooperatively provide a two-dimensional range of motion of a distal free end of the beam that is plus/minus 1.9 microns horizontally and +/−5.25 microns vertically.

8. The apparatus of claim 1, wherein the first and second plate portions have a thickness of 40 microns.

9. The apparatus of claim 1, wherein the IC package substrate comprises a horizontal surface facing and adjacent the PIC die, and wherein the first plate portion extends horizontally and parallel to the surface in a non-activated state.

10. The apparatus of claim 9, wherein the second plate portion extends vertically.

11. The apparatus of claim 9, comprising an array of the beams horizontally spaced from each other and each beam extending horizontally relative to the surface in a non-activated state.

12. The apparatus of claim 1, wherein the optical component is one of:
another PIC die wherein the optical path comprises one or more waveguides,
an optical interposer wherein the optical path comprises one or more waveguides, or
a portion of the package substrate having the optical path in proximity to the second waveguide.

13. An apparatus, comprising:
an integrated circuit (IC) package substrate;
a photonic integrated circuit (PIC) die over or under the IC package substrate and comprising at least one first waveguide;
an optical component adjacent the PIC die and comprising at least one second waveguide; and
at least one beam cantilevered from the PIC die or optical component and having a free distal end and a third waveguide extending along a length of the beam and between one of the first waveguides and one of the second waveguides,
wherein the individual beams comprise a first portion having a first transverse cross-section with a horizontally extending plate-shape, a second portion distal to the first portion on the beam and having a second traverse cross-section with a vertically extending plate shape, and wherein the third waveguide extends through the first and second portions.

14. The apparatus of claim 13, wherein the beam comprises a rigid middle portion intersecting the first and second portions.

15. The apparatus of claim 14, wherein the middle portion has a transverse cross-section relative to the length that is rectangular, a plus-shape, or an inverted T-shape.

16. The apparatus of claim 13, comprising two actuators, each actuator being adjacent one of the first and second portions and having a piezoelectric material, and wherein the piezoelectric material has a thickness of 1-15 microns, and wherein the thickness of the first and second portions is 10-50 microns.

17. A system, comprising:
a package substrate;
a photonic integrated circuit (PIC) die comprising a plurality of first waveguides; and
an optical interposer comprising:
a body,
a plurality of second waveguides in the optical interposer, and
an array of beams cantilevered from the body, wherein individual ones of the beams have a third waveguide positioned between one of the first waveguides and one of the second waveguides, and wherein individual ones of the beams comprise a first plate portion extending in a horizontal or vertical plane, and a second plate portion distal from the first plate portion along a length of the beam and extending transversely to the first plate portion, wherein the first and second plate portions have transverse cross-sections relative to the length that have a plate-shape, and wherein the third waveguide extends along both the first and second plate portions.

18. The system of claim 17, comprising two actuators, each actuator being adjacent a different one of the first and second plate portions and having a piezoelectric material.

19. The system of claim 18, comprising a control circuit electrically coupled to the actuators and providing 3.5 microns vertical displacement per volt and 0.6 microns horizontal displacement per volt at a free distal end of the beam when the first and second portions are 40 microns thick and the actuators are 5 microns thick.

20. The system of claim 18, comprising a pair of actuator stacks each having a first conductive feature on a different one of the first and second plate portions, one of the actuators each on one of the first conductive features, and a second conductive feature on each of the actuators.
